(19) United States
(12) Patent Application Publication
(10) Pub. No.: US 2024/0150520 A1
(43) Pub. Date: May 9, 2024

(54) ALTERNATING POLY(LACTIC-CO-GLYCOLIC ACID) AND METHODS OF MAKING AND USING SAME

(71) Applicants: Cornell University, Ithaca, NY (US); University of Pittsburgh - of the Commonwealth System of Higher Education, Pittsburgh, PA (US)

(72) Inventors: Geoffrey W. Coates, Lansing, NY (US); Yiye Lu, Ithaca, NY (US); Tara Y. Meyer, Pittsburgh, PA (US)

(21) Appl. No.: 18/546,039

(22) PCT Filed: Feb. 10, 2022
(86) PCT No.: PCT/US2022/016038

§ 371 Date: Aug. 10, 2023

Related U.S. Application Data
(60) Provisional application No. 63/148,132, filed on Feb. 10, 2021.

(51) Int. Cl. C08G 63/08; C08G 63/84

(52) U.S. Cl. CPC C08G 63/08; C08G 63/84

(57) ABSTRACT

Methods for regioselective ring-opening polymerization of unsymmetrical cyclic diester monomers, polymers, which may be made by the methods, and uses of same. Monomers may include cyclic hydroxy-acid dimers, such as, for example, 3-methyl glycolide and the like. Polymerization initiators may include chiral metal alkoxide initiators, such as, for example, (SalBinam)Al-01Pr initiators and the like. Polymers may include polyesters, such as, for example, poly(lactic-co-glycolic acid) (PLGA) and the like, with 90% or greater regioselectivity for alternating ester units (e.g., glycolic unit-lactic unit (G—L) linkages). Polymers may be utilized for substained or targeted drug delivery vehicles, scaffolding for tissue engineering, bioabsorbable sutures, or the like.

### CROSS-REFERENCE TO RELATED APPLICATIONS

This application claims the benefit of U.S. Provisional Patent Application No. 63/148,132, filed Feb. 10, 2021, the contents of the above-identified application are hereby fully incorporated herein by reference in their entirety.

### STATEMENT REGARDING FEDERALLY SPONSORED RESEARCH

This invention was made with government support under grant no. DE-FG02-05ER15687 awarded by the Department of Energy and under grant nos. 1901635, 1709144, and 1531632 awarded by the National Science Foundation. The government has certain rights in the invention.

### BACKGROUND OF THE DISCLOSURE

Polymer sequence control—the precise arrangement of monomer units in a macromolecule—is an important technique for tuning copolymer properties, as well as developing functional materials. Among synthetic biomaterials, the random copolymer poly(lactic-co-glycolic acid) (PLGA) has garnered significant interest due to its nontoxic hydrolytic degradation pathway in vivo, with tunable degradation rates and a glass transition temperature (T_{g}) that lies just above human body temperature. The utility of PLGA has been demonstrated in a variety of applications including sustained or targeted drug delivery vehicles, scaffolding for tissue engineering, and bioabsorbable sutures. The conventional copolymerization of the cyclic diesters lactide (LA) and glycolide (GA), however, produces a random copolymer with little control over monomer sequence. Thus, it is of great interest to develop a sequence-controlled PLGA, and to study the effect of monomer placement on polymer properties.

Alternating PLGA is a particularly attractive sequence variant because this material exhibits distinct degradation properties compared with other microstructures in terms of hydrolysis rates, bulk morphology and thermal behavior. It has been demonstrated that with the same LA/GA composition, higher quantities of G—G linkages (G=glycolic unit) result in faster degradation rates, as they are more susceptible to hydrolysis than G—L or L—L linkages (L=lactic unit). Alternating PLGA, which bears no G—G or L—L linkages, undergoes slow hydrolysis with linear degradation rates, and a sustained drug release profile relative to random PLGA 50/50. Additionally, the alternating material minimizes sudden local pH changes and in vivo inflammatory response associated with acid release. During the degradation of alternating PLGA, the morphology is preserved over a long period of time, without significant swelling or erosion, and its T_{g} remains largely unchanged. This linkage dependent hydrolytic behavior is also observed for other PLGA derivatives and polyesters. Block copolymers with alternating PLGA segments also present special properties suitable for thermosensitive hydrogels, controlled drug release and lithography. When self-assembled into micelles, the sequenced structure can further affect the solubility, hydrophilicity and gel point, offering another approach to tune the gelation properties and drug delivery performance.

PLGA is synthesized by the ring-opening polymerization (ROP) of LA and GA, yielding a random copolymer. An alternative method is step-growth segmer assembly polymerization (SAP), which produces PLGA with a repeating sequence that depends on the preformed oligomer used. Although this direct poly-condensation is reliable for producing high fidelity alternating PLGA, the SAP method does not allow for molecular weight control, with dispersities (Ð) ranging from 1.3 to 2. ROP of 3-methyl glycolide (MeG) has also been used to prepare alternating PLGA, with varying degrees of sequence fidelity.

Previous studies on the random copolymerization of GA and LA reveal that the rate of GA incorporation is ten times than that of LA and is attributed to the steric effect of the methyl substitution. The MeG monomer contains an LA acyl—O bond site and a GA acyl—O bond site. The ring-opening of MeG intrinsically favors the less hindered GA site, with a reported 84:16 ratio. It has been reported that ROP of other unsymmetrical cyclic diester monomers proceed with similar regioselectivity induced by ring-opening at the less hindered site. The metal alkoxide initiator (R)-(SalBinam)AlOR has been reported to preferentially promote ROP at the carbonyl next to an (R)—Me substituent in either rac- or meso-LA. However, near complete regioselectivity has only been achieved in a few cases using special conditions or monomers with strong steric or electronic bias. For example, a phosphazene base catalyzed ROP has been developed of enantiopure MeG with 95% regioselectivity at −78° C. due to the kinetically favored ring-opening at the more electrophilic LA acyl—O site. However, this electronic approach alone was unable to afford this level of regioselectivity at higher monomer loading or at ambient temperature.

### SUMMARY OF THE DISCLOSURE

In an aspect, the present disclosure provides methods of making polymers. In various examples, the present disclosure provides methods of making polyesters, such as, for example, poly(lactic-co-glycolic acid) (PLGA) or the like. In various examples, a method comprises a regioselective ring-opening polymerization of unsymmetrical cyclic monomers, such as, for example, unsymmetrical cyclic diester monomers or the like. In various examples, a method comprises: forming a reaction mixture comprising: one or more

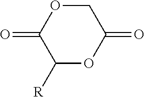

monomer(s); one or more initiator(s) of the form LM—X, where M is a metal, L is a polydentate ligand, and X is a ligand; and optionally one or more solvent(s); where a polymer or polymers is/are formed in the reaction mixture. In various examples, R is independently at each occurrence an alkyl group (e.g, a C₁-C₈ alkyl group, such as, for example, a methyl group or the like), an aryl group, or the like. In various examples, an X ligand is independently at each occurrence a hydroxide group, an alkoxide group (—OR′) (e.g., an isopropyl oxide group or the like), an aryloxide group (—OAr), an alkyl group, an ester group, an amido group, an azide group, or the like. In various examples, an M metal is independently at each occurrence aluminum, zinc, yttrium, or the like. In various examples, an L polydentate ligand is independently at each occurrence a N,N′-bis(salicylidene)-1,1′-binaphthyl-2,2′-diamine (SalBinam) ligand, a N,N′-bis(salicylidene)-1,2-diaminocyclohexane (Salcy) ligand, an analog thereof, a derivative thereof, or the like. In various examples, one or more or all of the initiator(s) is/are (R)- , (S)- , or rac-(SalBinam)Al—OⁱPr initiator(s), (R, R)-, (S, S)-, or mixed-(R, R)/(S, S)-(Salcy)AlOⁱPr initiator(s), analog(s) thereof, derivative(s) thereof, or any combination thereof. In various examples, a method comprises, after forming a polymer, adding one or more quenching agent(s) (e.g., water, mineral acid(s), a carboxylic acid(s), a carboxylic anhydride(s), a halocarboxylic acid(s), a halocarboxylic anhydride(s), an alcohol(s), or the like, or any combination thereof) to a reaction mixture. In various examples, a method comprises isolating and/or purifying a polymer. In various examples, a method makes a polymer having one or more structural feature(s) and/or one or more propert(ies) of polymers of the present disclosure.

In an aspect, the present disclosure provides polymers comprising alternating repeat units. In various examples, the present disclosure provides a polymer comprising alternating ester repeat units, such as, for example, alternating glycolic unit-lactic unit (G—L) linkages (which in the alternative may be referred to as alternating glycolic group-lactic group (G—L) linkages or the like). In various examples, a polymer comprises (or has) the following structure:

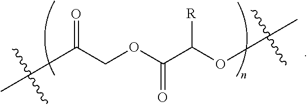

In various examples, n is from about 5 to about 1000. In various examples, R is independently at each occurrence an alkyl group (e.g., C₁-C₈ alkyl group, such as, for example, a methyl group or the like), an aryl group, or the like. In various examples, an end group is independently at each occurrence a hydroxide group, an alkoxide group, an aryloxide group, an alkyl group, an ester group, an amido group, an azide group, or the like. In various examples, a polymer comprises (or has) greater than about 90% glycolic unit-lactic unit (G—L) linkages. In various examples, a polymer is isotactic, isotactic-enriched, syndiotactic-enriched, syndiotactic, or atactic. In various examples, a polymer comprises (or has) a molecular mass (M_{w} and/or Mₙ) of from about 1 kiloDaltons (kDa) to about 130 kDa, and/or a dispersity (Ð) of from about 1.01 to about 3.0; and/or exhibits a glass transition temperature (T_{g}) of from about 30° C. to about 80° C.

In an aspect, the present disclosure provides articles of manufacture. In various examples, an article of manufacture comprises one or more polymer(s) of the present disclosure. In various examples, an article is a spun article, a molded article, an extruded article, a cast article, a blown article, a woven article, a drawn article, an extruded article, a laminated article, a spin coated article, an adhesive article, a 3D printed article, or the like.

### BRIEF DESCRIPTION OF THE FIGURES

For a fuller understanding of the nature and objects of the disclosure, reference should be made to the following detailed description taken in conjunction with the accompanying figures herein.

FIG. 1 shows stereo- and regioselective ring-opening polymerization using L^{R}Al—OⁱPr initiator or L^{S}Al—OⁱPr initiator.

FIGS. 2A-2D show stacked ¹H NMR spectra of poly(lactic-co-glycolic acid) (PLGA) with different regioselectivities (M:I=100:1). (FIG. 2A) Table 1, entry 11; (FIG. 2B) Table 1, entry 9; (FIG. 2C) Table 1, entry 5; (FIG. 2D) Table 1, entry 6.

FIGS. 3A-3C show NMR spectra used for the regioselectivity calculation. (FIG. 3A) HSQC (top) and HMBC (bottom) spectra showing methylene and carbonyl regions. (FIG. 3B) Sequence to which all three sets of minor CH₂ groups in FIG. 3A could be assigned. Group (a) is a glycolic unit-lactic unit (G—L) linkage preceding Group (b), a regioerror (G—G linkage), while Group (c) is a G—L linkage following Group (b), a regioerror (G—G linkage). (FIG. 3C) ¹H NMR spectrum of the sets of CH₂ groups shown in FIG. 3B used to calculate regioselectivity.

FIGS. 4A-4B show ring-opening site determination. (FIG. 4A) Non-selective ring-opening with HO—ⁱPr. (FIG. 4B) Selective ring-opening polymerization with L^{R}Al—OⁱPr.

FIG. 5 shows a proposed coordination insertion mechanism.

FIG. 6 shows a ¹H NMR spectra of polymers with high (98%) and low (85%) regioselectivities.

FIG. 7 shows ¹³C NMR spectra of polymers with high (98%) and low (85%) regioselectivities.

FIGS. 8A-8B show [Methyl-Glycolide]₀: [Initiator]₀=1:1 ring-opening site determination. (FIG. 8A) Opened non-selectively with HO—ⁱPr at 50° C., with conv.=4%. (FIG. 8B) Opened selectively with L^{R}Al—OⁱPr in CDCl₃ at 22° C. and then quenched with a drop of H₂O, with conv.=100%.

FIG. 9 shows polymer chain-end groups assignment with M:I=10:1.

FIG. 10 shows the ¹H NMR spectra of the sample from Table 1, entry 7, with regioselectivity=96% used in the sample calculation.

FIG. 11 shows the ¹H NMR spectra of the sample from Table 2, entry 14, with regioselectivity=85% used in the sample calculation.

FIG. 12 shows a representative polymer GPC trace of the sample from Table 1, entry 11.

FIG. 13 shows a proposed mechanism for syndiotactic enriched polymers from ROP of rac-MeG with rac-LAl—OⁱPr initiators, including rac-(SalBinam)Al—OⁱPr.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

As used herein, unless otherwise stated, the terms “about,” “approximately,” “substantially,” when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of +/−10% or less, +/−5% or less, +/−1% or less, and +/−0.1% or less of and from the specified value), insofar such variations are appropriate to perform in the context of the disclosure. As used herein, unless otherwise stated, the terms “about,” “approximate,” “at or about,” and “substantially” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent, trivalent, and the like, radicals). Illustrative examples of groups include:

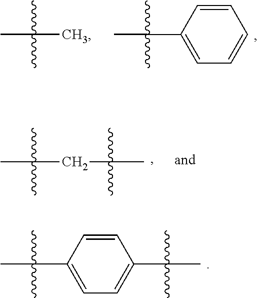

As used herein, unless otherwise indicated, the term “alkyl group” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group is C1 to C20, including all integer numbers of carbons and ranges of numbers of carbons therebetween (e.g., C1, C2, C3, C4, C5, C6, C7, C8, C9, C10, C11, C12, C13, C14, C15, C16, C17, C18, C19, and C20). An alkyl group may be unsubstituted or substituted with one or more substituent group(s). Examples of substituent group(s) include, but are not limited to, halide group(s) (—F, —Cl, —Br, and —I), aryl group(s), amine group(s), nitro group(s), ester group(s), carboxylate group(s), carboxylic acid(s), ether group(s) (e.g., polyether group(s), ether group(s) comprising a terminal alkyl group or aryl group or the like), hydroxy (—OH) group(s), and the like, and combinations thereof.

As used herein, unless otherwise indicated, the term “aryl group” refers to C5 to C30 aromatic or partially aromatic carbocyclic groups, including all integer numbers of carbons and ranges of numbers of carbons therebetween (e.g., C5, C6, C7, C8, C9, C10, C11, C12, C13, C14, C15, C16, C17, C18, C19, C20, C21, C22, C23, C24, C25, C26, C27, C28, C29, and C30). An aryl group may be unsubstituted or substituted with one or more substituent group(s). Examples of substituent group(s) include, but are not limited to, halide group(s) (—F, —Cl, —Br, and —I), amine group(s), nitro group(s), ester group(s), carboxylate group(s), carboxylic acid(s), ether group(s) (e.g., polyether group(s), ether group(s) (e.g., ether group(s) independently comprising a terminal alkyl or aryl group or the like), hydroxy (—OH) group(s), and the like, and any combination thereof. Aryl groups may contain hetero atoms, such as, for example, nitrogen (e.g., pyridinyl groups and the like). Such groups may be referred to as heteroaryl groups. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like.

As used herein, unless otherwise indicated, the term “analog” refers to a compound or group envisioned to arise from another compound or group, respectively, if one atom or group of atoms, functional group(s), or substructure(s) is/are replaced with another atom or group of atoms, functional group(s), or substructure(s).

As used herein, unless otherwise indicated, the term “derivative” refers to a compound or group that is derived from a similar compound or group, respectively, by one or more chemical reaction(s), where the compound or group is modified or partially substituted such that at least one structural feature of the original compound or group is retained.

In an aspect, the present disclosure provides methods of making polymers. In various example, the present disclosure provides methods of making polyesters, such as, for example, poly(lactic-co-glycolic acid) (PLGA), poly(L-lactic-co-glycolic acid) (PLLGA), poly(D-lactic-co-glycolic acid) (PDLGA), poly(D,L-lactic-co-glycolic acid)(PDLLGA), or the like. In various examples, a method comprises a regioselective ring-opening polymerization of unsymmetrical cyclic monomers, such as, for example, unsymmetrical cyclic diester monomers or the like. In various examples, a polymer is made by a method of the present disclosure and, optionally, comprises one or more structural feature(s) and/or exhibits one or more propert(ies) of a polymer of the present disclosure. Non-limiting examples of methods of making polymers are disclosed herein.

In various examples, a method of making a polymer comprises: forming a reaction mixture comprising: one or more monomer(s) having the following structure:

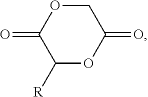

a stereoisomer thereof, or any combination thereof; and one or more initiator(s); where a polymer is formed in the reaction mixture. In various examples, R is independently at each occurrence an alkyl group, an aryl group, or the like. In various examples, R is independently at each occurrence a C₁-C₈ alkyl group or the like.

A reaction mixture can comprise various monomer(s). In various examples, a reaction mixture comprises (S)-, (R)-, or rac-

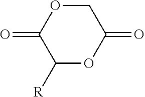

monomer(s) (e.g., (S)-, (R)-, or rac-

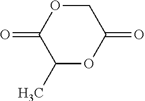

monomer(s), or the like). In various examples, a reaction mixture comprises a mixture of (S)- and (R)-

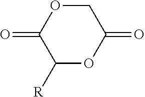

monomer(s) (e.g., (S)- and (R)-

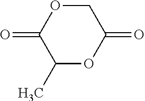

monomer(s) or the like). In various examples, a reaction mixture comprises a mixture of (S)- and rac-

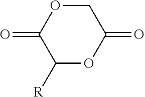

monomer(s) (e.g., (S)- and rac-

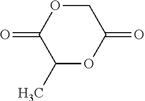

monomer(s) or the like). In various examples, a reaction mixture comprises a mixture of (R)- and rac-

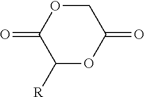

monomer(s) (e.g., (R)- and rac-

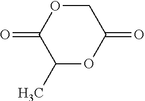

monomer(s) or the like). In various examples, a reaction mixture comprises only enantiopure

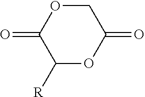

monomer(s) (e.g., only enantiopure

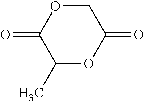

monomer(s) or the like).

A reaction mixture can comprise various initiator(s). In various examples, at least one or more or all initiator(s) independently at each occurrence has/have the form LM—X, where M is a metal, L is a polydentate ligand, and X is a ligand. In various examples, L is independently at each occurrence a N,N′-bis(salicylidene)-1,1′-binaphthyl-2,2′-diamine (SalBinam) ligand, a N,N′-bis(salicylidene)-1,2-diaminocyclohexane (Salcy) ligand, an analog thereof, a derivative thereof, or the like, or any combination thereof. In various examples, M is independently at each occurrence aluminum, zinc, yttrium, or the like, or any combination thereof. In various examples, X is independently at each occurrence a hydroxide group, an alkoxide group, an aryloxide group, an alkyl group, an ester group, an amido group, an azide group, or the like. In various examples, X is independently at each occurrence an alkoxy (—OR′) group (e.g., a poly(alkoxy ether) group, such as, for example, a poly(ethylene glycol) group and the like), an aryloxy (—Ar) group, an ester (—OC(═O)R′) group, or the like. In various examples, R′ is independently at each occurrence an isopropyl group, a methyl group, an ethyl group, a polyethylene glycol monomethyl ether group, a phenyl group, a benzyl group, a 1-naphthyl group, a 2-naphthyl group, a 1-naphthylmethyl group, a 2-naphthylmethyl group, or the like. In various examples, Ar is an aryl group. In various examples, a reaction mixture comprises (R)-, (S)-, rac-, (R, R)-, (S, S)-, or mixed (R, R)/(S, S)-LM—X initiator(s), or the like, or any combination thereof. In various examples, a reaction mixture comprises only enantiopure initiator(s).

In various examples, at least one or more or all N,N′-bis(salicylidene)-1,1′-binaphthyl-2,2′-diamine (SalBinam) ligand(s) independently at each occurrence has/have the following structure:

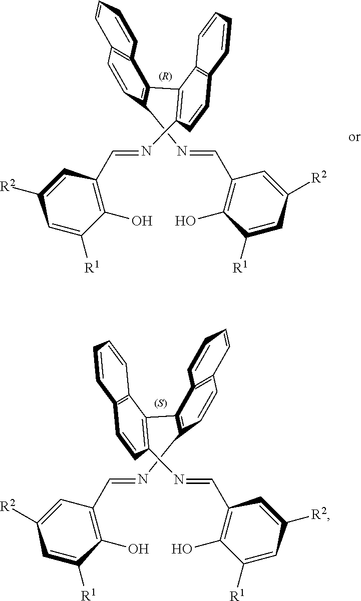

where R¹ and R² are each independently at each occurrence a hydrogen group, a halide group, an alkyl group, an alkoxy (e.g., a —OR′ group), an aryl group, or the like. In various examples, R¹ and R² are each independently at each occurrence a hydrogen group, a methyl group, a methoxy group, a chloro group, a bromo group, an iodo group, a phenyl group, a butyl group, a 3-bromopropyl group, or the like.

In various examples, one or more or all N,N′-bis(salicylidene)-1,2-diaminocyclohexane (Salcy) ligand(s) independently at each occurrence has/have the following structure:

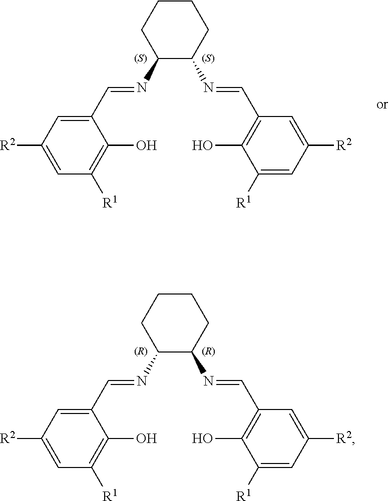

where R¹ and R² are each independently at each occurrence a hydrogen group, a halide group, an alkyl group, an alkoxy (—OR′) group, an aryl group, an aryloxy (—OAr) group, or the like. In various examples, R¹ and R² are each independently at each occurrence a hydrogen group, a methyl group, a methoxy group, a chloro group, a bromo group, an iodo group, a phenyl group, a butyl group, a 3-bromopropyl group, or the like. In various examples, Ar is an aryl group.

In various examples, at least one or more or all initiator(s) independently at each occurrence is/are (R)-, a (S)-, or a rac-(SalBinam)M—X initiator, a (R, R)-, a (S, S)-, or a mixed (R, R)/(S, S)-(Salcy)M—X initiator, an analog thereof, a derivative thereof, or any combination thereof.

In various examples, a (SalBinam)M—X initiator has the following structure:

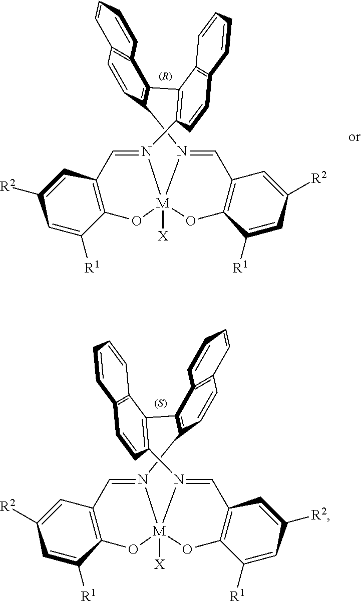

or a combination thereof, where R¹ and R² are each independently at each occurrence a hydrogen group, a halide group, an alkyl group, an alkoxy (e.g., a —OR′ group), or an aryl group, M is independently at each occurrence aluminum, zinc, yttrium, or the like, and X is independently at each occurrence a hydroxide group, an alkoxide group, an aryloxide group, an alkyl group, an ester group, an amido group, an azide group, or the like.

In various examples, at least one or more or all (Salcy)M—X initiator(s) independently at each occurrence has/have the following structure:

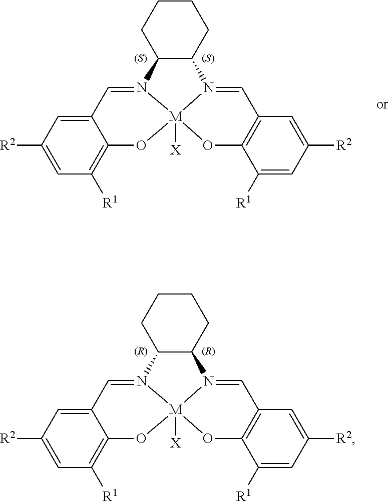

or a combination thereof, where R¹ and R² are each independently at each occurrence a hydrogen group, a halide group, an alkyl group, an alkoxy (e.g., a —OR′ group), or an aryl group, M is independently at each occurrence aluminum, zinc, yttrium, or the like, and X is independently at each occurrence a hydroxide group, an alkoxide group, an aryloxide group, an alkyl group, an ester group, an amido group, an azide group, or the like.

In various examples, at least one or more or all of an initiator(s) independently at each occurrence is a (R)-, a (S)-, or a rac-(SalBinam)M—OR′ initiator, a (R, R)-, a (S, S)-, or a mixed (R, R)/(S, S)-(Salcy)M—OR′ initiator, an analog thereof, a derivative thereof, or any combination thereof, where R′ is independently at each occurrence an isopropyl group, a methyl group, an ethyl group, a polyethylene glycol monomethyl ether group, a phenyl group, a benzyl group, a 1-naphthyl group, a 2-naphthyl group, a 1-naphthylmethyl group, a 2-naphthylmethyl group, or the like. In various examples, at least one or more or all initiator(s) independently at each occurrence is/are a (R)-, (S)-, or rac-(SalBinam)AlOⁱPr initiator, a (R, R)-, (S, S)-, or mixed (R, R)/(S, S)-(Salcy)AlOⁱPr initiator, an analog thereof, or any combination thereof.

In various examples, at least one or more or all initiator(s) independently at each occurrence has/have the following structure:

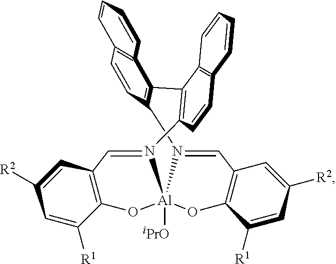

where R¹ and R² are each independently at each occurrence a hydrogen group, a halide group, an alkyl group, an alkoxy group (e.g., a —OR′ group), or an aryl group. In various examples, R¹ and R² are each independently at each occurrence a hydrogen group, a methyl group, a methoxy group, a chloro group, a bromo group, an iodo group, a phenyl group, a butyl group, or a 3-bromopropyl group.

A reaction mixture can comprise various monomer-initiator combinations. In various examples, a reaction mixture comprises: an (S-monomer and an (R)- , (S)- , rac- , (R, R)-, (S, S)-, or mixed (R, R)/(S, S)-initiator (e.g., LM—X or the like); an (R)-monomer and an (R)-, (S)-, rac-, (R, R)-, (S, S)-, or mixed (R, R)/(S, S)-initiator (e.g., LM—X or the like); or a rac-monomer and an (R)-, (S)-, rac-, (R, R)-, (S, S)-, or mixed (R, R)/(S, S)-initiator (e.g., LM—X or the like). In various examples, a reaction mixture comprises: (S-

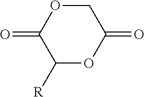

monomer(s) (e.g., (S-

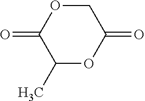

and the like) and (R)—LM—X initiator(s) (e.g., (R)- (SalBinam)AlOⁱPr initiator(s) and the like); (R)-

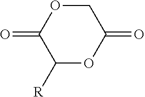

monomer(s) (e.g., (R)-

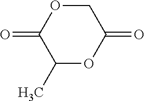

and the like) and (S)—LM—X initiator(s) (e.g., (S-(SalBinam)AlOⁱPr initiator(s) and the like); or rac-

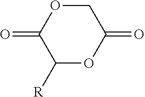

monomer(s) (e.g., rac-

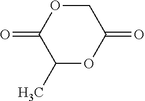

or the like) and rac-LM—X initiator(s) (e.g., rac-(SalBinam)AlOⁱPr initiator(s) and the like).

A reaction mixture may further comprise one or more various solvent(s). In various examples, at least one or more or all solvent(s) is/are chosen from aromatic solvents, chlorinated solvents, ether solvents, and any combination thereof. In various examples, at least one or more or all solvent(s) is/are toluene, tetrahydrofuran, chloroform, dichloromethane, benzene, dichloroethane, tetrachloromethane, dioxane, dimethoxyethane, or the like, or any combination thereof. In various examples, a reaction mixture does not comprise a solvent.

A reaction mixture can comprise various amounts of reagent(s). In various examples, at least one or all monomer(s) is/are present in the reaction mixture at from about 0.05 M to about 3 M, including all 0.1 mM values and ranges therebetween (e.g., from about 0.05 M to about 3 M, from about 0.1 M to about 2.5 M, or from about 0.25 M to about 2 M) (e.g., 0.5 M or 1.0 M). In various examples, a reaction mixture comprise various amounts of initiator(s). In various examples, at least one or all initiator(s) is/are present in the reaction mixture at from about 0.001 M to about 0.5 M or greater, including all 0.1 mM values and ranges therebetween (e.g., about 0.001 M to about 0.5 M, about 0.002 M to about 0.25 M, about 0.003 M to about 0.2 M, or about 0.004 M to about 0.1 M). In various examples, a molar ratio of monomer(s) to initiator(s) in a reaction mixture is from about 1:1 to about 1000:1, including all 0.1 molar ratio values and ranges therebetween (e.g., from about 1:1 to about 1000:1, from about 2:1 to about 900:1, from about 3:1 to about 750:1, from about 4:1 to about 500:1, or from about 5:1 to about 400:1) (e.g., from about 5:1 to about 1000:1, such as, for example, 100:1).

A method can be performed under various reaction conditions. In various examples, a reaction mixture is heated to, cooled to, maintained at, or the like, or any combination thereof, a temperature. In various examples, a reaction mixture is heated to, cooled to, maintained at, or the like, or any combination thereof, a temperature of from about −40° C. to about 100° C., including all 0.1° C. values and ranges therebetween (e.g., from about −20° C. to about 90° C., from about 0° C. to about 75° C., from about 10° C. to about 50° C., or from about 20° C. to about 30° C.). In various examples, the temperature is heated to, cooled to, maintained at, or the like, or any combination thereof, at the temperature for from about 1 hour (h=hour(s)) to about 50 h, including all integer second values and ranges therebetween (e.g., from about 5 h to about 40 h, from about 10 h to about 30 h, or from about 16 h to about 24 h).

A polymerization reaction can be a regioselective polymerization reaction. In various examples, a polymerization reaction in a reaction mixture is a regioselective ring-opening polymerization reaction which forms a polymer (e.g., poly(lactic-co-glycolic acid) or the like) comprising a plurality of alternating ester linkages (e.g., glycolic group-lactic group (G—L) linkages and the like) via opening of glycolic acyl—O bond site(s) of a

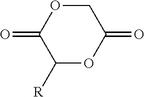

monomer (e.g., a

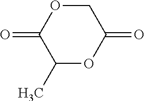

and the like). In various examples, regioselectivity is the number (or percentage) of alternating linkages (e.g., (G—L) linkages and the like) formed by glycolic acyl—O bond site ring-opening polymerization.

A polymerization reaction can be a living polymerization reaction. In various examples, a polymerization reaction in a reaction mixture is a living polymerization comprises formation of a polymer comprising a plurality of living end groups (e.g., LM-groups from the initiator or the like).

A polymerization reaction can be a copolymerization reaction. In various examples, a method comprises adding to the reaction mixture one or more additional monomer(s) (e.g., additional monomer(s) that can be polymerized with the monomer(s) in a ring-opening polymerization or the like to form a copolymer). In various examples, a method comprises simultaneously adding one or more monomer(s) and one or more additional monomer(s) to the reaction mixture to form a copolymer (e.g., a random copolymer or the like). In various examples, a method comprises forming a polymer before adding to the reaction mixture one or more additional monomer(s) to form a (monomer-block-additional monomer) copolymer. In various examples, a method comprises adding to the reaction mixture one or more additional monomer(s) to form a polymer prior to adding the one or more monomer(s) to form an (additional monomer-block-monomer) copolymer.

A polymerization reaction can be carried out until a desired level of monomer to polymer conversion is achieved. Various techniques for determining monomer to polymer conversion are known in the art. Non-limiting examples of techniques for determining monomer to polymer conversion include nuclear magnetic resonance (NMR) spectroscopy (e.g., ¹H NMR, ¹³C NMR, or the like), and the like. In various examples, polymer conversion is determined by one or more of these polymer conversion determination technique(s). In various examples, a polymerization reaction is carried out until reaching a monomer to polymer conversion of from about 20% to about 100% conversion, including all integer % values and ranges therebetween (e.g., from about 50% to about 99%, from about 60% to about 98%, or from about 70% to about 95%).

A method can comprise various post-polymerization steps. In various examples, a method further comprises, after forming the polymer, quenching, isolating, purifying the polymer, or any combination thereof. In various example, the method further comprises, after forming the polymer, adding one or more quenching agent(s) to the reaction mixture (e.g., to quench the living LM-end groups). In various examples, at least one or all quenching agent(s) is/are mineral acid(s), carboxylic acid(s), carboxylic anhydride(s), halocarboxylic acid(s), halocarboxylic anhydride(s), alcohol(s), or any combination thereof. In various examples, at least one or all quenching agent(s) is/are acetic acid, acetic anhydride, trifluoroacetic acid, trifluoroacetic anhydride, water, benzoic acid, or the like, or any combination thereof.

In various examples, a method further comprises, after forming a polymer, isolating the polymer. Various isolation techniques are known in the art. Non-limiting examples of techniques of isolating a polymer include precipitation, coagulation, centrifugation, filtration, solvent evaporation via heat or in vacuo, or the like. In various examples, a polymer is isolated by one or more of these isolation technique(s). In various examples, the polymer is isolated by removing the solvent in vacuo, centrifugation, filtration, or the like, or any combination thereof.

In various examples, a method further comprises, after forming a polymer,

purifying the polymer. Various purification techniques are known in the art. Non-limiting examples of purification techniques include chromatography, centrifugation, dialysis, precipitation, extraction, and the like. In various examples, a polymer (e.g., an isolated polymer or the like) is purified by one or more of these purification technique(s). In various examples, a polymer is purified by dissolving the polymer in a solvating solvent followed by precipitation of the polymer by addition of an excess of a non-solvating solvent.

In various examples, the present disclosure provides polymers. In various examples, a polymer comprises (or is) a polyester. In various examples, a polymer comprises (or is) poly(lactic-co-glycolic acid)(PLGA), poly(L-lactic-co-glycolic acid) (PLLGA), poly(D-lactic-co-glycolic acid) (PDLGA), poly(D,L-lactic-co-glycolic acid)(PDLLGA), or the like. In various examples, a polymer is made by a method of the present disclosure. Non-limiting examples of polymers are disclosed herein.

A polymer can comprise (or have) various chemical structures. Methods of determining chemical structure are known in the art. Non-limiting examples of methods of determining chemical structure include electronic spectroscopy (e.g., ultraviolet-visible (UV) spectroscopy, and the like), vibrational spectroscopy (e.g., infrared (IR) spectroscopy, Raman spectroscopy, and the like), nuclear magnetic resonance (NMR) spectroscopy (e.g. ¹H NMR, ¹³C NMR, and the like), electron spin resonance (ESR) spectroscopy, x-ray diffraction (XRD), mass spectrometry (MS), and the like. In various examples, the structure of a polymer is determined by one or more of these chemical structure determination techniques.

A polymer can comprise (or have) various side groups. In various examples, the side groups are pendant from the polymer backbone. In various examples, the side groups are chosen from alkyl groups or aryl groups, and the like, and any combination thereof. In various examples, the side groups are chosen form C₁-C₈ alkyl groups and the like. In various examples, at least a portion of or all of the side groups are methyl groups.

In various examples, a polymer comprises (or has) the following structure:

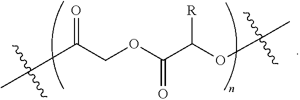

In various examples, n is from about 5 to about 1000, including all integer values and ranges therebetween (e.g., from about 5 to 400). In various examples, and R is independently at each occurrence chosen from alkyl groups, aryl groups, and the like.

A polymer can comprise (or have) various end groups. In various examples, the end groups result from the polymerization reaction(s) or the end groups can result from post polymerization reaction(s) (e.g., quenching, derivatization reaction(s), or the like) selected to provide desired end groups. Suitable post polymerization reactions are known in the art. Methods of end group analysis are known in the art. Non-limiting examples of end group analysis include NMR spectrometry (e.g., ¹H NMR, ¹³C NMR, or the like), MS, vibrational spectroscopy (e.g., IR spectroscopy, Raman spectrometry, or the like), and the like. In various examples, the end group(s) of a polymer are determined by one or more of these end group analysis technique(s).

In various examples, at least 50% (e.g., about 50% or greater, about 60% or greater, about 70% or greater, about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, about 94% or greater, about 95% or greater, about 96% or greater, about 97% or greater, about 98% or greater, or about 99% or greater) of the end groups (e.g., from a terminal lactic group and/or a terminal glycolic group of a PLGA chain) are independently at each occurrence chosen from a hydroxide group, alkoxide groups, aryloxide groups, alkyl groups, ester groups, amido groups, azide groups, and the like.

In various examples, at least 50% (e.g., about 50% or greater, about 60% or greater, about 70% or greater, about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, about 94% or greater, about 95% or greater, about 96% or greater, about 97% or greater, about 98% or greater, or about 99% or greater) of the end groups are hydrogen groups resulting in secondary alcohol chain ends (e.g., from a terminal lactic group and/or a terminal glycolic group of a PLGA chain). In various examples, one or more or all polymer chains comprise a terminal lactic group comprising a secondary alcohol chain end (e.g., a hydrogen group). In various examples, one or more or all polymer chains do not comprise a secondary alcohol chain end.

In various examples, a polymer comprises (or has) the following structure:

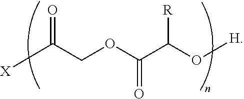

In various examples, R and n are defined above. In various examples, X is independently at each occurrence (e.g., X is independently for each individual polymer chain) a hydroxide group, an alkoxide group, an aryloxide group, an alkyl group, an ester group, an amido group, an azide group, or the like. In various examples, X is independently at each occurrence an alkoxy (—OR′) group (e.g., a poly(alkoxy ether) group, such as, for example, a poly(ethylene glycol) group and the like), an aryloxy (—OAr) group, an ester (—OC(═O)R′) group, or the like. In various examples, R′ is independently at each occurrence an isopropyl group, a methyl group, an ethyl group, a polyethylene glycol monomethyl ether group, a phenyl group, a benzyl group, a 1-naphthyl group, a 2-naphthyl group, a 1-naphthylmethyl group, a 2-naphthylmethyl group, or the like. In various examples, Ar is an aryl group). In various examples, a polymer has the following structure:

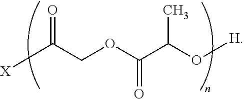

A polymer can comprise (or have) various regioselectivity. In various examples, regioselectivity of a polymer is the number (or percentage) of alternating linkages (e.g., ester linkages, such as, for example, (G—L) linkages or the like) in the polymer. Various regioselectivity determination techniques are known in the art. Non-limiting examples of methods to determine polymer regioselectivity include nuclear magnetic resonance (NMR) spectroscopy (e.g. ¹H NMR, ¹³C NMR, and the like), and the like. In various examples, the regioselectivity of a polymer (e.g., the percentage of glycolic unit-lactic unit (G—L) linkages of a PLGA) is determined by one or more of these regioselectivity determination technique(s). In various examples, a polymer (or a domain/domains thereof) comprises (or has) a regioselectivity of about 50% or greater (e.g., about 60% or greater, about 70% or greater, about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, about 94% or greater, about 95% or greater, about 96% or greater, about 97% or greater, about 98% or greater, or about 99% or greater). In various examples, a polymer (or a domain/domains thereof) comprises a regioselectivity of about 90% or greater. In various examples, a polymer (or a domain/domains thereof) comprises (or has) a regioselectivity of from about 50% to about 100% (e.g., from about 85% to about 100%, or from about 90% to about 100%) including all 0.1% values and ranges therebetween.

A polymer can comprise (or have) various tacticity. Various tacticity determination techniques are known in the art. Non-limiting examples of methods of determining tacticity include nuclear magnetic resonance (NMR) Spectroscopy (e.g., ¹H NMR, ¹³C NMR, and the like), x-ray diffraction (XRD), mass spectrometry (MS), and vibrational spectroscopy (FTIR), and the like. In various examples, the tacticity of a polymer is determined by one or more of these tacticity determination technique(s). In various examples, a polymer is isotactic, isotactic-enriched, syndiotactic, syndiotactic-enriched, or atactic. In various examples, an isotactic polymer has a Pᵣ value of about 0, an isotactic-enriched polymer has a Pᵣ value of less than about 0.5, an atactic polymer has a Pᵣ value of about 0.5, a syndiotactic-enriched polymer has a Pᵣ value of greater than about 0.5, and a syndiotactic polymer has a Pᵣ value of about 1, where Pᵣ=√([rr]%), where [rr]% is the percentage of raceme triads, based on the total number of [rr], [mm] (meso triads), and [rm/mr] (heterotactic triads), where ([rr]%+[rm/mr]%+[mm]%)=100%.

A polymer can comprise (or have) various molecular mass (M_{w} and/or Mₙ) and/or dispersity (Ð) values. Various techniques of determining molecular mass (M_{w} and/or Mₙ) and dispersity (Ð) are known in the art. Non-limiting examples of techniques to determine molecular mass (M_{w} and/or Mₙ) and dispersity (Ð) include gel permeation chromatography (GPC) and the like. In various examples, molecular weight (M_{w} and/or Mₙ) is determined by GPC. In various examples, a polymer has a molecular mass (M_{w} and/or Mₙ) of from about 1 kiloDaltons (kDa) to about 130 kDa (e.g., from about from about 1 kDa to about 130 kDa, from about 2 kDa to about 100 kDa, from about 5 kDa to about 75 kDa, from about 10 kDa to about 40 kDa, or from about 15 kDa to about 30 kDa), including all integer kDa values and ranges therebetween. In various examples, a polymer has a dispersity (Ð) of from about 1.01 to about 3.0 (e.g., from about 1.01 to about 3.0, from about 1.02 to about 2.0, from about 1.03 to about 1.8, or from about 1.05 to about 1.3), including all 0.01 Ð values and ranges therebetween.

A polymer can exhibit various thermal properties. Methods of measuring thermal properties (e.g., thermal transitions or the like) are known in the art. Non-limiting examples of methods of measuring thermal properties include Differential Scanning Calorimetry (DSC), and the like. In various examples, a polymer comprises (or has) a glass transition temperature (T_{g}) of from about 30° C. to about 80° C. (e.g., from about 30° C. to about 80° C., from about 35° C. to about 70° C., or from about 40° C. to about 60° C.), including all 0.1° C. values and ranges therebetween. In various examples, a polymer has a T_{g} of about 30° C. or greater, about 40° C. or greater, about 50° C. or greater, about 60° C. or greater, about 70° C. or greater, or about 80° C.

A polymer can comprise (or have) various morphologies. Methods of determining polymer morphology are known in the art. Non-liming examples of methods of determining polymer morphology include x-ray diffraction, thermal analysis, and the like. In various examples, the morphology of a polymer is determined by one or more of these methods of determining polymer morphology. In various examples, a polymer is amorphous or semicrystalline. In various examples, a polymer comprises (or has) one or more amorphous domain(s), one or more crystalline domain(s), or any combination thereof. In various examples, a polymer exhibits one or more detectable amorphous domains or one or more detectable crystalline domains. In various examples, a polymer is completely amorphous. In various examples, a polymer does not exhibit any detectable crystalline domains.

A polymer can comprise (or have) various forms. In various examples, the polymer in the form of a solution, an emulsion, a slurry, a dispersion, a particle, a flake, a pellet, a powder, a granule, a tube, a sphere, a fiber, a foam, a film, a textile, a mesh, a sheet, a bar, a monolith, or the like.

A polymer can be a homopolymer or a copolymer. In various examples, a copolymer comprises (or has) one or more polymer domain(s) (comprising one or more polymer(s) of the present disclosure) and/or one or more additional polymer domain(s) (comprising one or more polymer(s) other than polymers of the present disclosure). In various examples, a copolymer is a block copolymer, a random copolymer, a tapered copolymer, or the like. A copolymer can comprise (or have) various additional repeat units. Additional repeat unit(s) may be present in a copolymer as one or more block(s), distributed (e.g., randomly, tapered, or the like) in the copolymer, or the like. In various examples, an additional repeat unit or additional repeat units is/are formed from additional monomer(s) that can be polymerized in ring-opening polymerizations and the like. In various examples, a copolymer comprises (e.g., in one or more domain(s) or one or more block(s), or the like) the following structure:

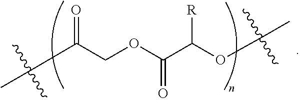

In various examples, a copolymer is formed by copolymerization of additional monomer(s) with

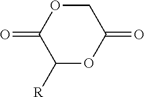

monomer(s) (e.g.,

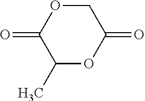

and the like). In various examples, an additional repeat unit or additional repeat units is/are chosen from additional ester repeat units, and the like. In various examples, one or more or all repeat unit(s) comprises (or is) an ester group. A copolymer can comprise one or more polymer domain(s) having the same or different tacticity.

In an aspect, the present disclosure provides compositions. In various examples a composition comprises one or more polymer(s) of the present disclosure. Non-limiting examples of compositions are disclosed herein.

A composition may further comprise one or more additional component(s). In various examples, additional component(s) render the composition suitable for use in biomedical applications, industrial applications, pharmaceutical applications, or the like. In various examples, a composition further comprises polyethylene glycol, chitosan, alginate, cyclodextrins, sucrose, proline, lysine, silicon oxide, polyethylene elastomers, or the like, or any combination thereof.

In an aspect, the present disclosure provides uses of polymers of the present disclosure. In various examples, a polymer is used in biomedical applications, industrial applications, pharmaceutical applications, or the like. In various examples, a targeted drug delivery vehicle, a scaffold for tissue engineering, a bioabsorbable suture, or the like, comprises one or more polymer(s). Non-limiting examples of uses are disclosed herein.

An article of manufacture comprises one or more polymer(s). In various examples, an article is a spun article, a molded article, an extruded article, a cast article, a blown article, a woven article, a drawn article, an extruded article, a laminated article, a spin coated article, an adhesive article, or a 3D printed article. Articles of manufacture can be used in various applications. In various examples, an article of manufacture is used in packaging, a consumer products, biomedical devices, industrial products, pharmaceutical compositions, or the like.

The following Statements describe various examples of methods, polymers, and articles of manufacture of the present disclosure and are not intended to be in any way limiting:
Statement 1. A method of making a polymer comprising: forming a reaction mixture comprising: one or more monomer(s) having the following structure:

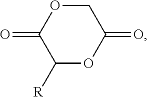

where R is independently at each occurrence chosen from alkyl groups, aryl groups, and any combination thereof; one or more initiator(s) independently at each occurrence comprising the following structure: LM—X, where M is a metal, L is a polydentate ligand, and X is a ligand chosen from a hydroxide group, alkoxide groups, aryloxide groups, alkyl groups, ester groups, amido groups, and azide groups; and optionally one or more solvent(s); where a polymer is formed.
Statement 2. A method according to Statement 1, where the reaction mixture comprises: (S)-

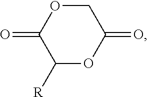

### and (R)—LM—X; (R)-

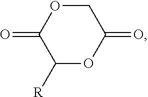

and (S)—LM—X; or rac-

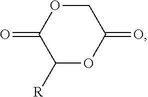

and rac-LM—X.
Statement 3. A method according to Statement 1 or Statement 2, where the ligand (X) of at least one of the initiator(s) is an alkoxide group.
Statement 4. A method according to any one of Statements 1-3, where the metal (M) of at least one of the initiator(s) is chosen from aluminum, zinc, yttrium, and any combination thereof.
Statement 5. A method according to any one of Statements 1-4, where the polydentate ligand (L) of at least one of the initiator(s) is chosen from N,N′-bis(salicylidene)-1,1′-binaphthyl-2,2′-diamine (SalBinam) ligands, N,N′-bis(salicylidene)-1,2-diaminocyclohexane (Salcy) ligands, analogs thereof, derivative(s) thereof, and any combination thereof.
Statement 6. A method according to any one of Statements 1-5, where at least one of the initiator(s) is chosen from (R)-(SalBinam)M—OR′ initiator(s), (S)-(SalBinam)M—OR′ initiator(s), rac-(SalBinam)M—OR′ initiator(s), (R, R)-(Salcy)M—OR′ initiator(s), (S, S)-(Salcy)M—OR′ initiator(s), analog(s) thereof, derivative(s) thereof, and any combination thereof, where —OR′ is chosen from alkoxy groups, aryloxy groups, ester groups, and any combination thereof.
Statement 7. A method according to any one of Statements 1-6, where at least one of the initiator(s) is chosen from (R)-(SalBinam)AlOⁱPr initiators, (S)-(SalBinam)AlOⁱPr initiators, and rac-(SalBinam)AlOⁱPr initiators, (R, R)-(Salcy)AlOⁱPr initiator(s), (S, S)-(Salcy)AlOⁱPr initiator(s), analog(s) thereof, derivative(s) thereof, and any combination thereof.
Statement 8. A method according to any one of Statements 1-7, where at least one of the initiator(s) has the following structure:

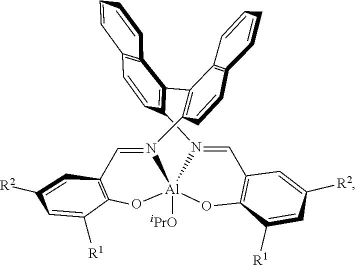

where R¹ and R² are each independently at each occurrence chosen from a hydrogen group, halide groups, alkyl groups, alkoxy groups, and aryl groups.
Statement 9. A method according to any one of Statements 1-8, where at least one of the monomer(s) is

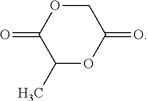

Statement 10. A method according to any one of Statements 1-9, where the reaction mixture comprises: (S)-

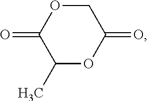

and (R)-(SalBinam)AlOⁱPr initiators; (R)-

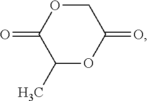

and (S)-(SalBinam)AlOⁱPr initiators; or rac-

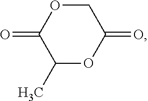

and rac-(SalBinam)AlOⁱPr initiators.
Statement 11. A method according to any one of Statements 1-10, where at least one of the monomer(s) is present in the reaction mixture at from about 0.05 M to about 3 M, including all 0.1 mM values and ranges therebetween.
Statement 12. A method according to any one of Statements 1-11, where the molar ratio of the monomer(s) to the initiator(s) in the reaction mixture is from about 5:1 to about 1000:1, including all 0.1 molar ratio values and ranges therebetween.
Statement 13. A method according to any one of Statements 1-12, where at least one of the solvent(s) is chosen from aromatic solvents, chlorinated solvents, and ether solvents, and any combination thereof.

Statement 14. A method according to any one of Statements 1-13, where the reaction mixture is heated to, cooled to, or held, or any combination thereof, at a temperature of from about −40° C. to about 100° C., including all 0.1° C. values and ranges therebetween.
Statement 15. A method according to Statement 14, where the reaction mixture is heated to, cooled to, or held, or any combination thereof, at the temperature for from about 1 hours to about 50 hours, including all integer second values and ranges therebetween.
Statement 16. A method according to any one of Statements 1-15, further comprising, after forming the polymer, adding one or more quenching agent(s) to the reaction mixture.
Statement 17. A method according to Statement 16, where at least one of the quenching agent(s) is chosen from water, mineral acid(s), carboxylic acids, carboxylic anhydrides, halocarboxylic acids, halocarboxylic anhydrides, alcohols, and any combination thereof.
Statement 18. A method according to any one of Statements 1-17, further comprising, after forming the polymer, isolating and/or purifying the polymer.
Statement 19. A method according to any one of Statements 1-18, where the polymer comprises greater than about 90% glycolic unit-lactic unit (G—L) linkages.
Statement 20. A polymer comprising the following structure:

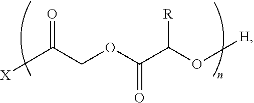

where n is from about 5 to about 1000, including all integer values and ranges therebetween, where R is independently at each occurrence chosen from alkyl groups and aryl groups, and where X is chosen from a hydroxide group, alkoxide groups, aryloxide groups, alkyl groups, ester groups, amido groups, azide groups, and any combination thereof.
Statement 21. A polymer according to Statement 20, where the polymer comprises greater than about 90% glycolic unit-lactic unit (G—L) linkages.
Statement 22. A polymer according to Statement 20 or Statement 21, where the polymer has the following structure:

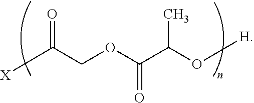

Statement 23. A polymer according to any one of Statements 20-22, where the polymer is isotactic, isotactic-enriched, syndiotactic-enriched, or atactic.
Statement 24. A polymer according to any one of Statements 20-23, where the polymer has a molecular mass (M_{w} and/or Mₙ) of from about 1 kiloDaltons (kDa) to about 130 kDa, including all integer kDa values and ranges therebetween.
Statement 25. A polymer according to any one of Statements 20-24, where polymer has a dispersity (Ð) of from about 1.01 to about 3.0, including all 0.01 Ð values and ranges therebetween.
Statement 26. A polymer according to any one of Statements 20-25, where the polymer has a glass transition temperature (T_{g}) of from about 30° C. to about 80° C., including all 0.1° C. values and ranges therebetween.
Statement 27. A polymer according to any one of Statements 20-26, where the polymer in the form of a solution, an emulsion, a slurry, a dispersion, a particle, a flake, a pellet, a powder, a granule, a tube, a sphere, a fiber, a foam, a film, a textile, a mesh, a sheet, a bar, or a monolith.
Statement 28. An article of manufacture comprising one or more polymer(s) of claim 20.
Statement 29. An article according to Statement 28, where the article is a spun article, a molded article, an extruded article, a cast article, a blown article, a woven article, a drawn article, an extruded article, a laminated article, a spin coated article, an adhesive article, or a 3D printed article.
Statement 30. A method of preparing a polymer comprising: providing a reaction mixture comprising:

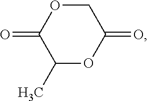

an initiator, and a solvent; maintaining the reaction mixture at a first temperature; optionally, adding a quenching agent to the reaction mixture; and optionally isolating the polymer formed from polymerization of

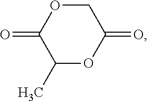

where the polymer has substantial regioselectivity.
Statement 31. A method according to Statement 30, where the initiator is chosen from (R)-(SalBinam) AlOR′, (S)-(SalBinam)AlOR′, rac-(SalBinam)AlOR′, where R′ is a hydrogen or an alkyl group or aryl group or alkylaryl group.
Statement 32. A method according to Statement 31, where the initiator is (R)-(SalBinam) AlOⁱPr, (S)-(SalBinam)AlOⁱPr, and rac-(SalBinam)AlOⁱPr.
Statement 33. A method according to any one of the preceding Statements, where the solvent is chosen from toluene, tetrahydrofuran, chloroform, dichloromethane, benzene, dichloroethane, tetrachloromethane, dioxane, dimethoxyethane, and the like, and combinations thereof.
Statement 34. A method according to any one of the preceding Statements, where the concentration of

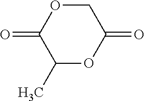

is 0.05 to 3 M, including all 0.1 mM values and ranges therebetween.
Statement 35. A method according to any one of the preceding Statements, where the quenching agent is acetic acid, trifluoroacetic acid, water, benzoic acid, and the like, and combinations thereof. Statement 36. A method according to any one of the preceding Statements, where the ratio of

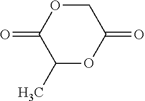

to the initiator is 5:1 to 1000:1, including all 0.1 ratio values and ranges therebetween.
Statement 37. A method according to any one of the preceding Statements, where reaction mixture comprises:

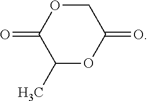

Statement 38. A method according to any one of Statements 30-36, where the reaction mixture comprises:

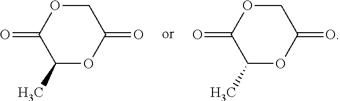

Statement 39. A method according to any one of the preceding Statements, where the regioselectivity is greater than 85%, greater than 86%, greater than 87%, greater than 88%, greater than 89%, greater than 90%, greater 91%, greater than 92%, greater than 93%, greater than 94%, greater than 95%, greater than 96%, greater than 97% or greater than 98%.
Statement 40. A method according to any one of the preceding Statements, where the first temperature is −40 to +100° C., including all 0.1° C. values and ranges therebetween.
Statement 41. A method according to any one of the preceding Statements, where the reaction mixture is maintained at the first temperature for 1 to 50 hours, including all integer second values and ranges therebetween.
Statement 42. A method according to any one of Statements 30-37 or 39-41, where the reaction mixture comprises:

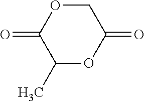

and rac-(SalBinam)AlOⁱPr.
Statement 43. A method according to any one of Statements 30-37 or 39-41, where the reaction mixture comprises:

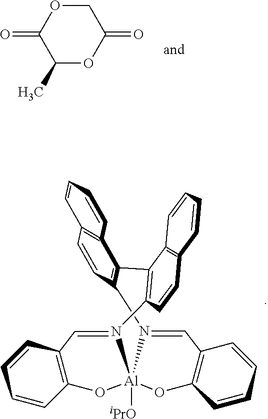

Statement 44. A method according to any one of the preceding Statements, where the dispersity (Ð) of the polymer is 1.01-3.0.
Statement 45. A method according to any one of the preceding Statements, where the polymer has a molecular mass of 1 to 130 kDa, including all Da values and rangers therebetween.
Statement 46. A method according to any one of Statements 30-37, 39-42, 44, or 45, where the polymer has the following structure:

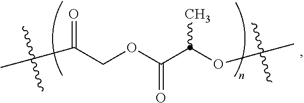

where n is 5 to 1000, including all integer values and ranges therebetween, where the chirality at the dotted carbon is R, S, or rac.
Statement 47. A method according to any one of Statements 30-36, 38, 39-41, 43, 44, or 45, where the polymer (e.g., copolymer) has the following structure:

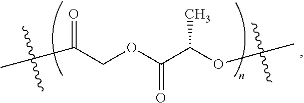

where n is 5 to 1000, including all integer values and ranges therebetween.
Statement 48. A method according to any one of Statements 30-36, 38, 39-41, 43, 44, or 45, where the polymer has the following structure:

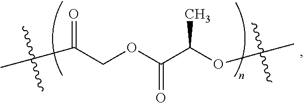

where n is 5 to 1000, including all integer values and ranges therebetween.
Statement 49. A method according to any one of Statements 30-37, 39-42, or 44-46, where the polymer has the following structure:

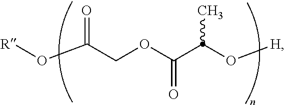

where n is 5 to 1000, including all integer values and ranges therebetween, the chirality at the dotted carbon is R, S, or rac, and R″ is the same as R′ group of the initiator according to Statement 31.
Statement 50. A method according to any one of Statements 30-36, 38, 39-41, 43-45, or 47 where the polymer has the following structure:

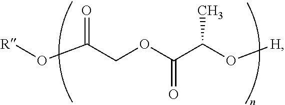

where n is 5 to 1000, including all integer values and ranges therebetween, and R″ is the same as R′ group of the initiator according to Statement 31.
Statement 51. A method according to any one of Statements 30-36, 38, 39-41, 43-45, or 48 where the polymer has the following structure:

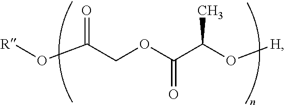

where n is 5 to 1000, including all integer values and ranges therebetween, and R″ is the same as R′ group of the initiator according to Statement 31.
Statement 52. A method according to any one of Statements 30-37, 39-42, 44-46, or 49, where the polymer (e.g., copolymer) has the following structure:

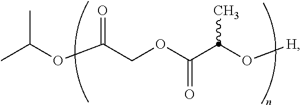

where n is 5 to 1000, including all integer values and ranges therebetween.
Statement 53. A method according to any one of Statements 30-36, 38, 39-41, 43-45, 47, or 50, where the polymer has the following structure:

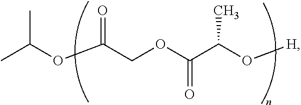

where n is 5 to 1000, including all integer values and ranges therebetween.
Statement 54. A method according to any one of Statements 30-36, 38, 39-41, 43-45, 47, or 51, where the polymer (e.g., copolymer) has the following structure:

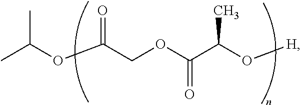

where n is 5 to 1000, including all integer values and ranges therebetween.
Statement 55. A polymer, where the polymer is prepared via the method of any one of the preceding Statements.
Statement 56. A polymer according to Statement 55, where the polymer is formed from the polymerization of

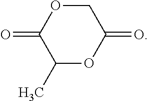

Statement 57. A polymer according to Statement 55 or Statement 56, where the polymer is formed from the polymerization of

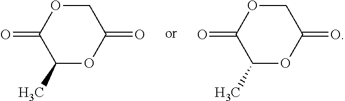

Statement 58. A polymer according to any one of Statements 55-56, where the polymer has the following structure:

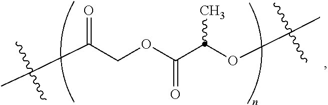

where n is 5 to 1000, including all integer values and ranges therebetween, where the chirality at the dotted carbon is R, S, or rac.
Statement 59. A polymer according to any one of Statements 55-57, where the polymer has the following structure:

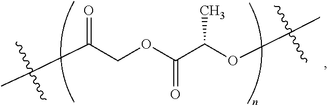

where n is 5 to 1000, including all integer values and ranges therebetween.
Statement 60. A polymer according to any one of Statements 55-57, where the polymer has the following structure:

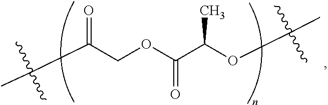

where n is 5 to 1000, including all integer values and ranges therebetween.
Statement 61. A polymer according to any one of Statements 55-58, where the polymer has the following structure:

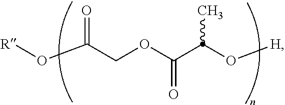

where n is 5 to 1000, including all integer values and ranges therebetween, the chirality at the dotted carbon is R, S, or rac, and R″ is the same as R′ group of the initiator according to Statement 31.
Statement 62. A polymer according to any one of Statements 55, 56, or 59, where the polymer has the following structure:

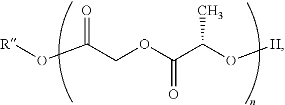

where n is 5 to 1000, including all integer values and ranges therebetween, and R″ is the same as R′ group of the initiator according to Statement 31.
Statement 63. A polymer according to any one of Statements 55, 56, or 60, where the polymer has the following structure:

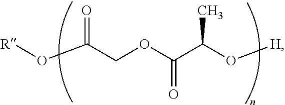

where n is 5 to 1000, including all integer values and ranges therebetween, and R″ is the same as R′ group of the initiator according to Statement 31.
Statement 64. A polymer according to any one of Statements 55, 56, 58, or 61, where the polymer has the following structure:

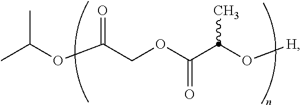

where n is 5 to 1000, including all integer values and ranges therebetween.
Statement 65. A polymer according to any one of Statements 55, 56, 59, or 62, where the polymer has the following structure:

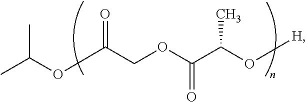

where n is 5 to 1000, including all integer values and ranges therebetween.
Statement 66. A polymer according to any one of Statements 55, 56, 60, or 63, where the polymer has the following structure:

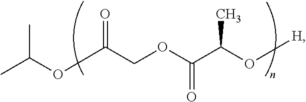

where n is 5 to 1000, including all integer values and ranges therebetween.
Statement 67. A polymer, where the polymer is formed from the polymerization of

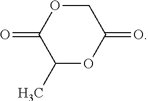

Statement 68. A polymer according to Statement 67, where the polymer is atactic, syndio-enriched, or iso-enriched.
Statement 69. A polymer according to Statement 67, where the polymer is formed from the polymerization of

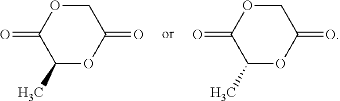

Statement 70. A polymer according to Statement 67 or 68, where the polymer has the following structure:

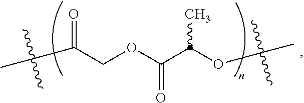

where n is 5 to 1000, including all integer values and ranges therebetween, where the chirality at the dotted carbon is R, S, or rac.
Statement 71. A polymer according to Statement 67 or 69, where the polymer has the following structure:

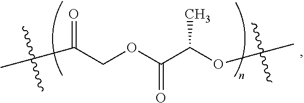

where n is 5 to 1000, including all integer values and ranges therebetween.
Statement 72. A polymer according to Statement 67 or 69, where the polymer has the following structure:

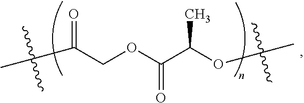

where n is 5 to 1000, including all integer values and ranges therebetween.
Statement 73. A polymer according to any one of Statements 67, 68, or 70, where the polymer has the following structure:

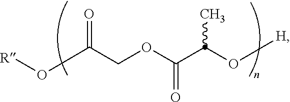

where n is 5 to 1000, including all integer values and ranges therebetween, the chirality at the dotted carbon is R, S, or rac, and R″ is the same as R′ group of the initiator according to Statement 31.
Statement 74. A polymer according to any one of Statements 67, 69, or 71, where the polymer has the following structure:

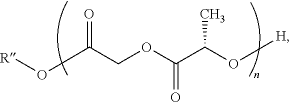

where n is 5 to 1000, including all integer values and ranges therebetween, and R″ is the same as R′ group of the initiator according to Statement 31.
Statement 75. A polymer according to any one of Statements 67, 69, or 72, where the polymer has the following structure:

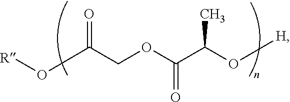

where n is 5 to 1000, including all integer values and ranges therebetween, and R″ is the same as R′ group of the initiator according to Statement 31.
Statement 76. A polymer according to any one of Statements 67, 68, 70, or 73, where the polymer has the following structure:

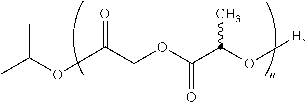

where n is 5 to 1000, including all integer values and ranges therebetween.
Statement 77. A polymer according to any one of Statements 67, 69, 71, or 74, where the polymer has the following structure:

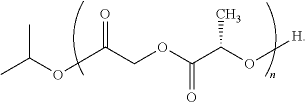

where n is 5 to 1000, including all integer values and ranges therebetween.
Statement 78. A polymer according to any one of Statements 67, 69, 72, or 75, where the polymer has the following structure:

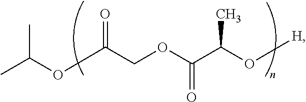

where n is 5 to 1000, including all integer values and ranges therebetween.
Statement 79. A polymer according to any one of Statements 55-78, where the polymer is amorphous or at least partially amorphous.

The steps of the methods described in the various examples disclosed herein are sufficient to carry out a method of the present disclosure. Thus, in various examples, a method consists essentially of a combination of the steps of the methods disclosed herein. In various other examples, a method consists of such steps.

The following examples are presented to illustrate the present disclosure. They are not intended to be limiting in any matter.

### Example 1

The following is an example of polymers of the present disclosure, methods of making and using same.

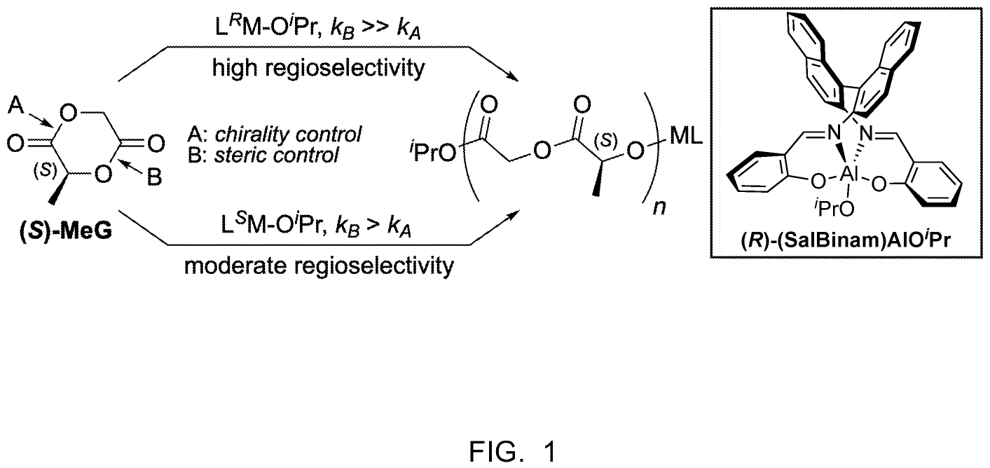

A completely regioselective MeG polymerization was catalyzed by (SalBinam)AlOR (Sal-Binam=N,N′-bis(salicylidene)-1,1′-binaphthyl-2,2′-diamine) (FIG. 1). It was believed that (R)-(SalBinam)AlOR blocks nucleophilic attack at the chirality mismatched (S)-LA carbonyl of rac-LA or meso-LA. On the basis of this chirality mismatch, it was hypothesized that (R)-(SalBinam)AlⁱPr would further discourage ring-opening at the (S)-LA site of (S)-MeG (FIG. 1). Thus, it was theorized that dual steric and chirality control might significantly favor ring-opening at the GA site. In this example, the synthesis of alternating PLGA is described from (S)-MeG with 98% regioselectivity, high efficiency, tailored molecular weight, and low dispersity.

Complex 1 (Table 1) exhibits a regioselectivity of 84% when applied for the ROP of MeG, with baseline monomer oriented steric control. Following the standard conditions for lactide polymerization reported previously, (S)-MeG ROP was examined at 70° C. in toluene with (R)-2. The dispersity was unexpectedly high, indicating significant transesterification. Lowering the temperature to 35° C. helped narrow the dispersity and increase the regioselectivity to 97% (Table 1, entries 2-4). When enantiomeric (S)-2 was used, the regioselectivity dropped from 97% to 84%. As expected, the regioselectivity with rac-2 ranked in between its enantiopure counterparts, indicating that while steric preference remained, the catalyst chirality was crucial for enhanced regioselectivity through chirality control (Table 1, entries 4-6). In order to access materials with a wide range of molecular weights, different ratios of monomer to initiator (M:I) were investigated. At a low monomer loading, transesterification started to dominate, leading to a high dispersity and low regioselectivity (Table 1, entries 4, 7 and 8).

TABLE 1
Optimization of Reaction Conditions.

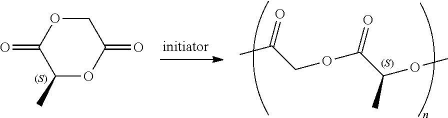

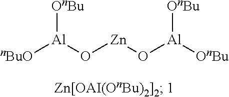

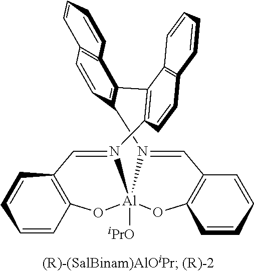

| | | | [MeG]₀: | | | | | | | regio- |
|---|---|---|---|---|---|---|---|---|---|---|
| | Initiator | | [Init.]₀ | temp. | time | conv. | M_{n theo} | M_{n GPC} | | selectivity |
| entry | (I) | solvent | (M:I)ª | (° C.) | (h) | (%)^{b} | (kDa) | (kDa)^{c} | (M_{w}/Mₙ)^{c} | (%)^{b} |
| 1^{d} | 1 | toluene | 131:1 | 90 | 4.5 | >99 | 8.5 | 8.3 | 1.44 | 84 |
| 2 | (R)-2 | toluene | 100:1 | 70 | 19 | 98 | 12.8 | 14.2 | 1.59 | 95 |
| 3 | (R)-2 | toluene | 100:1 | 50 | 17 | 80 | 10.4 | 10.1 | 1.30 | 96 |
| 4 | (R)-2 | toluene | 100:1 | 35 | 21 | 72 | 9.4 | 13.0 | 1.13 | 97 |
| 5 | rac-2 | toluene | 100:1 | 35 | 40 | >99 | 13.0 | 12.6 | 1.20 | 89 |
| 6 | (S)-2 | toluene | 100:1 | 35 | 40 | >99 | 13.0 | 13.8 | 1.27 | 84 |
| 7 | (R)-2 | toluene | 40:1 | 35 | 17 | 98 | 5.1 | 7.1 | 1.18 | 96 |
| 8 | (R)-2 | toluene | 10:1 | 35 | 12 | >99 | 1.3 | 2.0 | 1.29 | 90 |
| 9 | (R)-2 | CDCl₃ | 100:1 | 50 | 21 | 97 | 12.7 | 13.6 | 1.15 | 94 |
| 10 | (R)-2 | THF | 100:1 | 50 | 20 | 95 | 12.4 | 12.1 | 1.11 | 96 |
| 11 | (R)-2 | DCM | 100:1 | 35 | 21 | 94 | 12.2 | 15.8 | 1.06 | 98 |
| 12 | (S)-2 | DCM | 100:1 | 35 | 19 | 97 | 12.6 | 16.9 | 1.12 | 78 |
| 13 | (R)-2 | DCM | 200:1^{e} | 40 | 48 | 93 | 24.3 | 25.4 | 1.06 | 98 |
| 14 | (R)-2 | DCE | 400:1^{f} | 80 | 48 | 773 | 37.9 | 40.0 | 1.09 | 96 |
| 15 | (R)-2 | DCM | 40:1 | 22 | 21 | 99 | 5.1 | 9.0 | 1.05 | 98 |
| 16 | (R)-2 | DCM | 10:1 | 22 | 12 | >99 | 1.3 | 2.1 | 1.10 | 98 |

^{a}[MeG]₀ = 0.5 M.
^{b}Determined by ¹H NMR analysis.
^{c}Determined by GPC.
^{d}Data from Dong, C.-M.; Gu, K.-Y.; Gu, Z.-W.; Feng, X.-D. Living polymerization of D,L-3-methylglycolide initiated with bimetallic (Al/Zn) μ-oxo alkoxide and copolymers thereof. J. Polym. Sci., Part A: Polym. Chem. 2001, 39, 357-367.
^{e}[MeG]₀ = 1.0 M.
^{f}[MeG]₀ = 1.5 M

Polymerizations performed in toluene showed dispersities between 1.1-1.3 and limited conversion, likely due to low solubility of monomer and polymer. Preheating the reaction ensured complete dissolution of monomer at the start of the reaction period, producing PLGA with a slightly lower dispersity. To improve polymer solubility and reduce transesterification at low monomer loading, several solvents with good solubility were screened CDCl₃ exhibited near full conversion but lower regioselectivity, likely due to its slight acidity, which can facilitate side reactions. THF also produced high conversion, while other results were similar to reactions performed in toluene. DCM was determined to be the optimal solvent, considering solubility, conversion, dispersity and regioselectivity (Table 1, entries 4, 9-11). In addition, a higher molecular weight polymer could easily be reached at a prolonged reaction time. Using DCM as solvent also eliminated trans-esterification at low monomer loading, affording a 98% regioselectivity, and D as low as 1.05 (Table 1, entries 12-14).

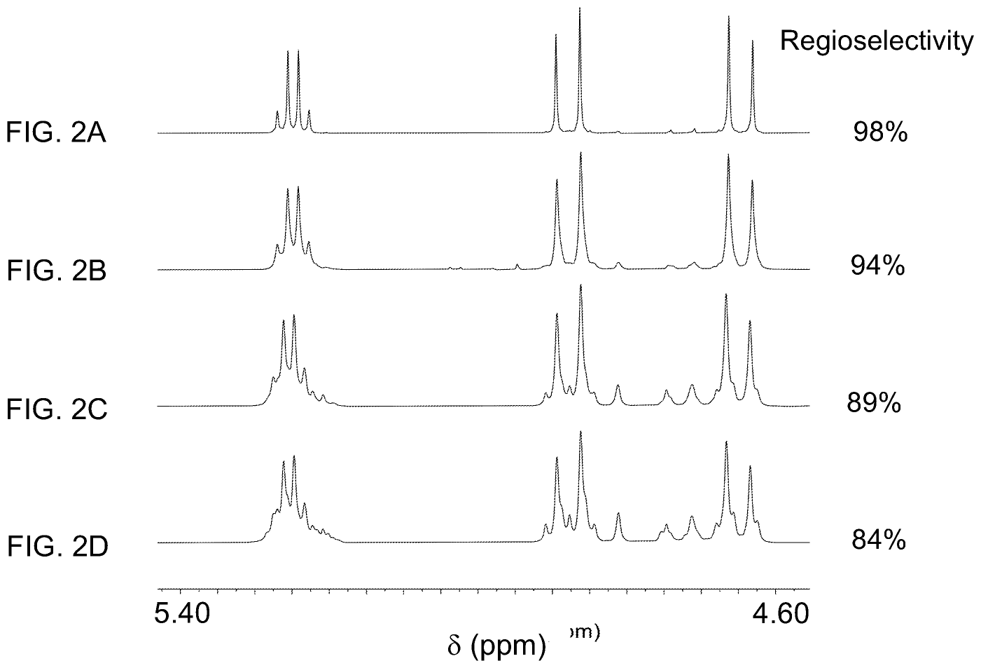

With the possible variations investigated, it was sought to design and synthesize a series of polymers with different regioselectivities for future degradation study. At a lower regioselectivity, there are more G—G linkages in the polymer chain, which is expected to have a faster degradation rate. FIGS. 2A-2D show a stacking of polymer ¹H NMR on methine (δ=5.2-5.3 ppm) and methylene (δ=4.6-4.9 ppm) regions, the regioselectivities of which range from 98% to 84%, in accordance with the reaction conditions in Table 1. At M:I=100:1, the chain end peaks are almost negligible in the spectra; the minor peaks are therefore assigned to regioerrors. Thus, a clear and gradual increase of regioerror peaks can be seen near the methine quartets and methylene doublets.

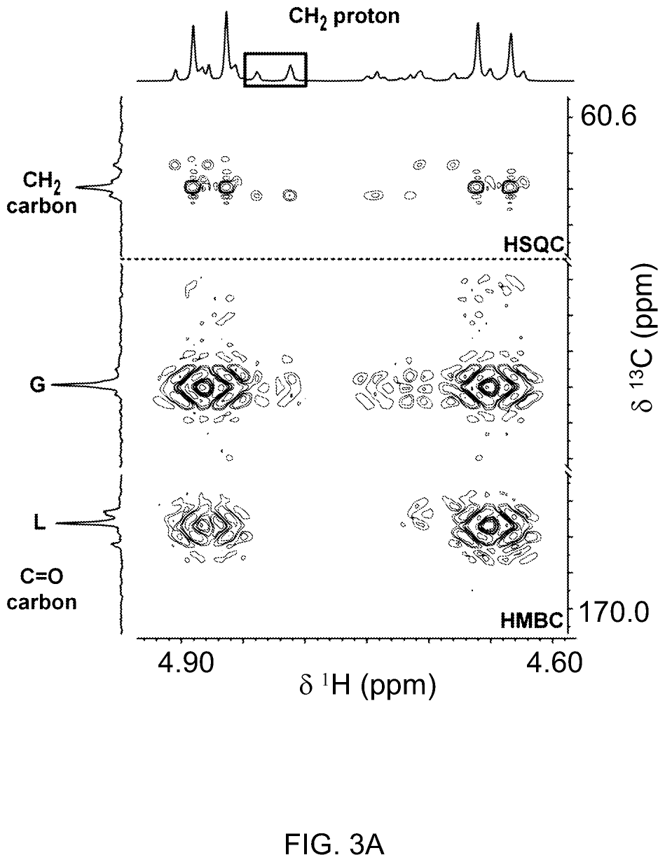

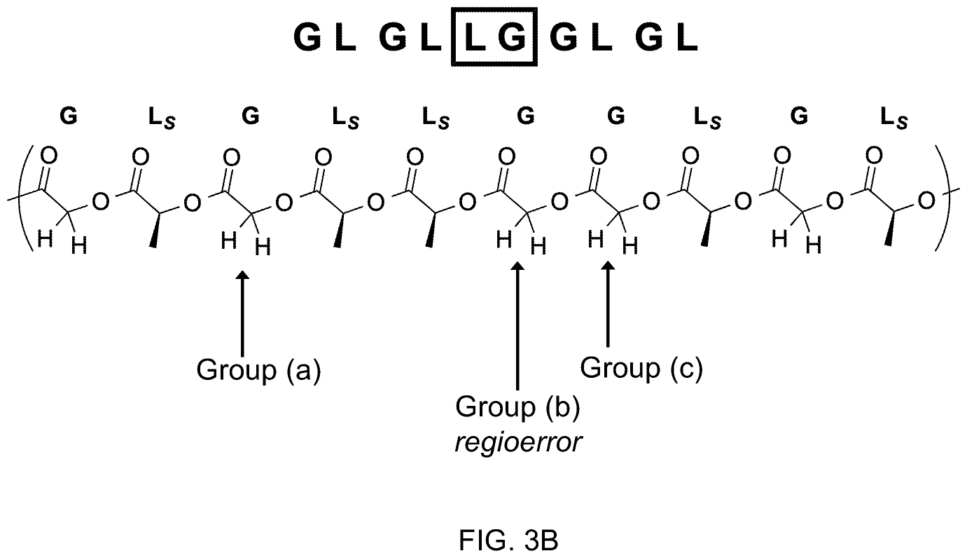

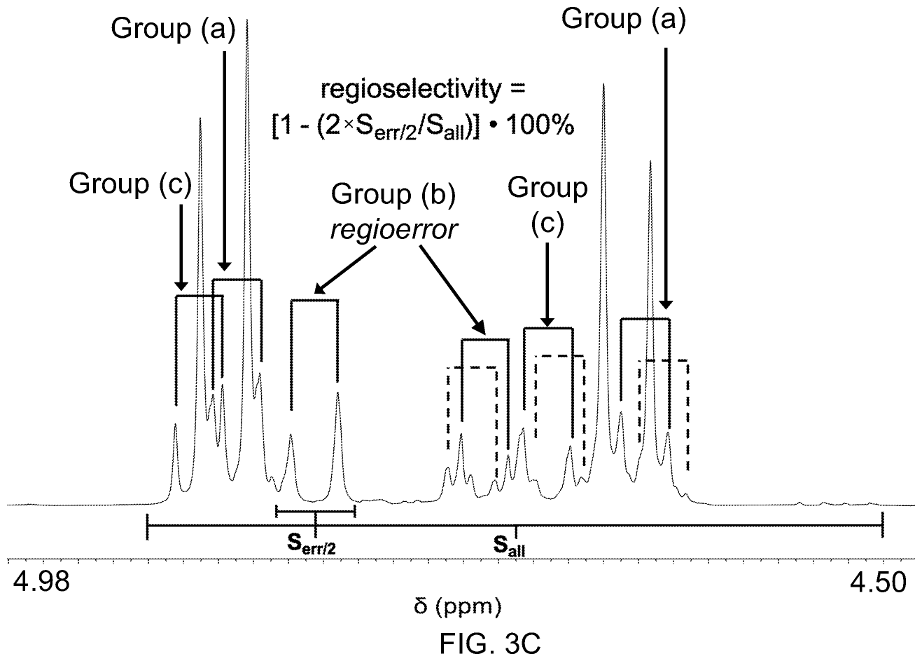

Effective sequence error determination, in this case regioselectivity calculation, is a crucial topic for sequence control. Previous studies on ROP of unsymmetrical cyclic diesters reported regioselectivities mostly qualitatively or by end group ratio. In fact, the polymer end group ratio does not necessarily represent the actual regioselectivity of the polymerization, as the two types of chain ends from normal insertion and error insertion have different propagation rates. Another calculation method was based on ¹H NMR decoupled methine region, but overlapping peaks impeded precise integration especially at near perfect regioselectivities. A quantitative method was developed based on integrations of accumulative repeating units using the most sensitive ¹H NMR methylene region. The HSQC (FIG. 3A, top) shows three sets of minor CH₂ doublets resulting from one regioerror (GLLGGL). Among these three minor CH₂ groups, one is directly derived from the error insertion (GLLGGL), while the other two are adjacent to the error under normal insertion (GLLGGL and GLLGGL). From the sequence structure, only the actual error CH₂ group (GLLGGL) would not have a three-bond correlation with an L carbonyl in the HMBC (FIG. 3A, bottom). Based on this, all three sets of minor CH₂ groups could be assigned to the sequence in FIG. 3B. Notably, half of this error CH₂ group (GLLGGL) (δ=4.80-4.85 ppm) can be integrated separately without any overlap, while the other half (δ=4.71-4.76 ppm) is overlapped and split due to the influence of an adjacent error in a row. Hence, precise NMR integration on half of the error CH₂ group (δ=4.80-4.85 ppm) and the overall CH₂ group (δ=4.50-4.92 ppm) allows the regioselectivity representative of the whole polymer to be accurately and reproducibly calculated (FIG. 3C).

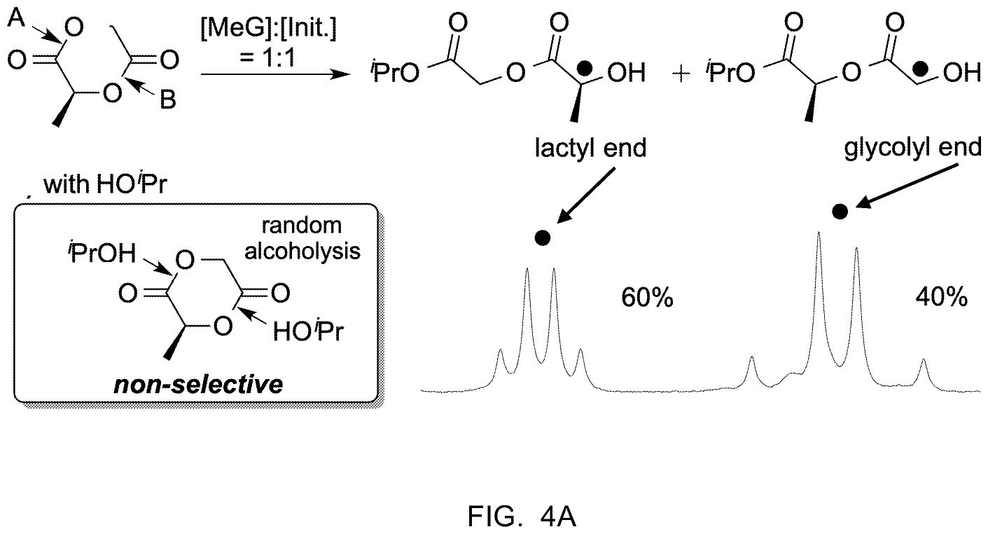

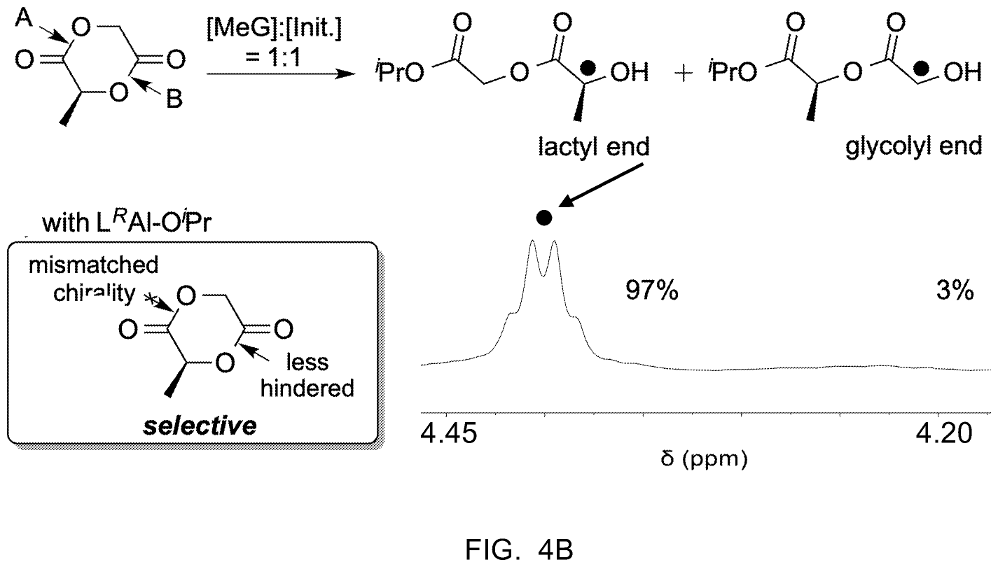

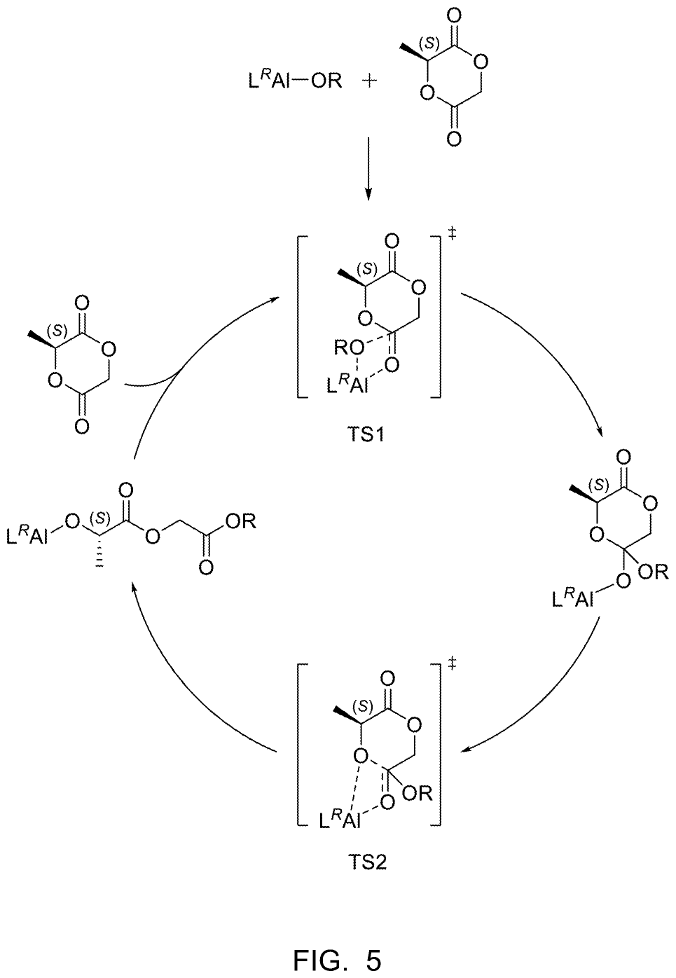

The proposed hypothesis is that ring-opening occurs preferentially at the less hindered GA site under steric control and is disfavored at the (S)-LA site with a mismatched catalyst under chirality control. In order to prove this idea, a [MeG]₀:[Initiator]₀=1:1 experiment and investigation of the initial ring-opened adducts was conducted. The ratio of resulting lactyl and glycolyl chain ends was used as an indication of regioselectivity. As a control experiment, iPrOH was used to open (S)-MeG, generating products in a 60:40 ratio of lactyl:glycolyl chain ends; (FIG. 4A). Using (R)-2, the lactyl-terminated product was formed in a 97% yield, indicating that nucleophilic attack occurred almost exclusively at the less hindered GA acyl—O bond site (FIG. 4B). As mentioned previously, (R)-2 preferentially promotes ring-opening at the (R)-LA site. By using (S)-MeG, a chirality mismatch with (R)-2 prevents the opening at the (S)-LA site, further improving regioselectivity. Moreover, the polymer NMR also displays exclusively lactyl chain ends. These results suggest that the ROP of (S)-MeG undergoes a site-controlled coordination-insertion mechanism (see proposed mechanism in FIG. 5), with near-exclusive ring-opening at the GA acyl—O bond site.

Thus, a chirality-directed regioselective approach for the sequence-controlled synthesis of PLGA has been developed. This process produces alternating PLGA under living chain growth conditions. Quantitative regioselectivity determination has been established for a precise sequence error determination.

Experimental Methods. All manipulations of air and water sensitive compounds were carried out under nitrogen in an MBraun Labmaster glovebox or by using standard Schlenk line technique. ¹H and ¹³C NMR spectra were recorded on Bruker AVANCE III HD (¹H, 400) spectrometer with a BBF/¹H broadband observe probe, Bruker AVANCE III HD (¹H, 500 MHz) spectrometer with a broadband Prodigy cryoprobe or Varian INOVA 600 (¹H, 600 MHz) spectrometer with a Varian 5 mm inverse, triple-resonance probehead. Two-dimensional NMR experiments were acquired on the Varian INOVA 600 (¹H, 600 MHz) spectrometer using standard pulse sequences bsgHSQCAD and bsgHMBC supplied in VnmrJ 3.2. All the NMR experiments were carried out at 25° C. and processed with MestReNova software 14.1.0. Chemical shifts (δ) for ¹H spectra were referenced to protons on the residual solvent (7.26 ppm for CDCl₃, 2.08 ppm for C₆D₅CD₃). Chemical shifts (δ) for ¹³C NMR spectra were referenced to deuterated solvent itself (77.16 ppm for CDCl₃). NMR-spectroscopic data are reported as follows: chemical shift, multiplicity (s=singlet, d=doublet, t=triplet, q=quartet, m=multiplet, br=broad), integration and coupling constants (Hz). High-resolution mass spectrometry (HRMS) analyses were performed on a Thermo Scientific Exactive Orbitrap MS system equipped with an Ion Sense DART ion source or an electrospray ionization (ESI) source.

Flash column chromatography was performed using silica gel (particle size 40-64 μm, 230-400 mesh). Gel permeation chromatography (GPC) analyses were carried out using an Agilent 1260 Infinity GPC System equipped with an Agilent 1260 Infinity autosampler and a refractive index detector. The Agilent GPC system was equipped with two Agilent PolyPore columns (5-micron, 4.6 mm ID) which were eluted with THF at 30° C., 0.3 mL/min and calibrated using monodisperse polystyrene standards.

Differential scanning calorimetry (DSC) measurements of polymer samples were performed on a Mettler-Toledo Polymer DSC instrument equipped with a chiller and an autosampler. Samples were prepared in aluminum pans. All polyesters were analyzed using the following heating program: −70° C. to 200° C. at 25° C. /min, 200 to −70° C. at 10° C./min, and then −70° C. to 200° C. at 25° C./min. Data were processed using StarE software. All reported glass transition temperatures were observed on the second heating cycle.

Solvents for air sensitive reactions were purchased from Fisher and sparged with ultra-high purity (UHP) grade nitrogen and either passed through two columns containing reduced copper (Q-5) and alumina (PhMe and THF) or passed through two columns of alumina (DCM) and dispensed into an oven-dried Straus flask, followed by three freeze-pump-thaw cycles, and vacuum transferred before use. Deuterated chloroform and deuterated toluene were purchased from Cambridge Isotope Laboratories, dried over calcium hydride for three days, vacuum transferred to an oven-dried Schlenk flask, degassed by three freeze-pump-thaw cycles, and stored under nitrogen. All solvents were stored over 3 Å molecular sieves. 3 Å molecular sieves were purchased from Strem and activated by heating at 200° C. under vacuum for 18 hours. Other bench-top solvents (EtOAc, hexanes, MeOH, EtOH, DCM, MeCN, CDCl₃, etc.) were used as received. All other chemicals and reagents were purchased from commercial sources (Aldrich, Oakwood Chemical, Strem, Advanced ChemBlocks Inc., TCI, Alfa Aesar, Acros, and Fisher) and used without further purification.

Monomer synthesis. The synthesis of (S)-3-methyl glycolide ((S)-MeG) followed Scheme 1, according to modified literature procedures.

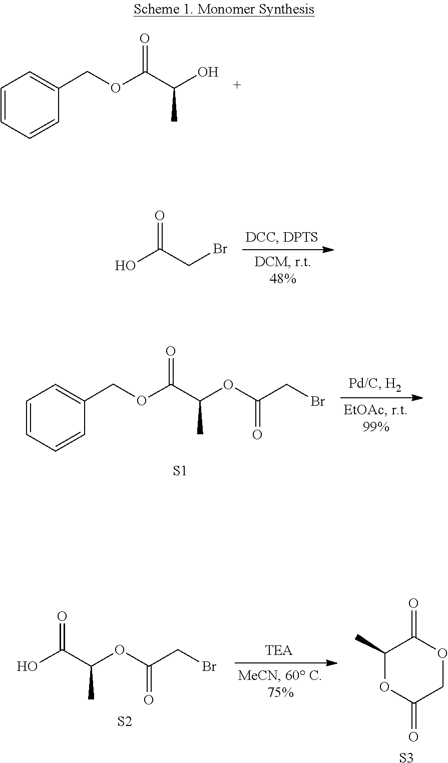

Benzyl (S)-2-(2-bromoacetoxy)propanoate (S1)

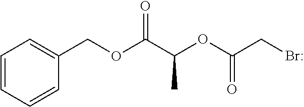

(S)-Benzyl lactate (23 g, 0.13 mol) and bromoacetic acid (20 g, 0.15 mol) were dissolved in dry DCM (500 mL, 0.25 M) in a flame dried Schlenk flask under nitrogen. 4-(Dimethylamino) pyridinium p-toluene sulfonate (DPTS) (5.9 g, 0.021 mol) and N,N′-dicyclohexylcarbodiimide (DCC) (28.5 g, 0.138 mol) were then added to the flask and the solution was allowed to stir overnight. The reaction mixture was then diluted with hexanes and filtered to remove dicyclohexylurea (DCU), and the filtrate was concentrated and purified via column chromatography (silica, EtOAc/hexanes) to yield a colorless oil (18.5 g, 48% yield). ¹H NMR (400 MHz, CDCl₃) δ 7.35 (m, 5H), 5.20 (m, 3H), 3.90 (s, 2H), 1.54 (d, J=7.1 Hz, 3H); ¹³C NMR (100 MHz, CDCl₃) δ 170.0, 166.8, 135.3, 128.8, 128.7, 128.4, 70.3, 67.4, 25.4, 16.9; HRMS (ESI): m/z calculated for C₁₂H₁₄BrO₄ [M+H]⁺301.00755, found 301.00745.

(S)-2-(2-Bromoacetoxy)propanoic acid (S2)

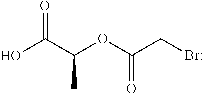

S1 (16.9 g, 56.1 mmol) and 10 wt. % Pd on carbon (26 g, ˜24 mmol Pd) were dissolved in EtOAc (1.2 L, 0.050 M) in a flame dried Schlenk flask under nitrogen. The flask was purged with H₂ twice, and then allowed to stir for 10 min at room temperature under 1 atm H₂. The reaction was monitored closely by TLC. Upon completion, the reaction mixture was filtered to recover catalyst, and filtered again over celite and concentrated in vacuo to yield an orange oil (11.6 g, 99% yield). Recovered catalyst could be dried and reused with similar activity several times. ¹H NMR (400 MHz, CDCl₃) δ 10.53 (s, 1H), 5.19 (q, J=7.1 Hz, 1H), 3.92 (s, 2H), 1.59 (d, J=7.2 Hz, 3H); ¹³C NMR (100 MHz, CDCl₃) δ 175.7, 166.8, 69.7, 25.2, 16.8; HRMS (ESI): m/z calculated for C₅H₈BrO₄ [M+H]⁺210.96060, found 210.94322.

(S)-3-Methyl-1,4-dioxane-2,5-dione (S3)

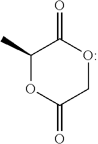

Distilled triethylamine (4.7 mL, 34 mmol) was dissolved in 275 mL of dry MeCN in a flame-dried three-neck flask with a condenser and addition funnel under nitrogen. A solution of S2 (5.8 g, 27 mmol) dissolved in 275 mL (550 mL total, 0.050 M) of dry MeCN was added dropwise through the addition funnel at 60° C. for 20 min. The reaction mixture was allowed to stir at 60° C. for an additional 10 min and was then quenched by adding 3 mL of AcOH. The reaction mixture was concentrated and purified via column chromatography (silica, EtOAc/hexanes) to yield a white solid (2.67 g, 75% yield). ¹H NMR (500 MHz, CDCl₃) δ 5.03 (q, J=6.8 Hz, 1H), 4.96 (d, J=16.5 Hz, 1H), 4.91 (d, J=16.5 Hz, 1H), 1.70 (d, J=6.8 Hz, 3H); ¹³C NMR (125 MHz, CDCl₃) δ 166.4 (d, J=1.3 Hz), 164.6 (d, J=1.4 Hz), 72.2, 65.7, 16.5; HRMS (ESI): m/z calculated for C₅H₇O₄ [M+H]⁺131.03443, found 131.03381. Spectral data matched those reported in the literature.

The product from column chromatography was heated to melt as a clear liquid and dried overnight under vacuum. When cooled down, it formed back to a chunk of white solid. It was then chopped down to small pieces and sublimed twice under vacuum at 40° C. The sublimed solids were collected and stored under nitrogen. For the small-scale sublimation (suitable for 50-1000 mg), crude product was placed in a 20 mL scintillation vial, equipped with a rubber septum and a needle. The combined vial was placed in a drying tube, heated under vacuum, until most solids got collected at the inner side of the rubber septum, with yellow liquid left at the bottom of the vial. The sublimed solids were scraped off and collected in a vial in glovebox. The monomer was then ready to use for polymerization.

Catalyst synthesis. (R)-(SalBinam)AlOⁱPr was synthesized according to Scheme 2.

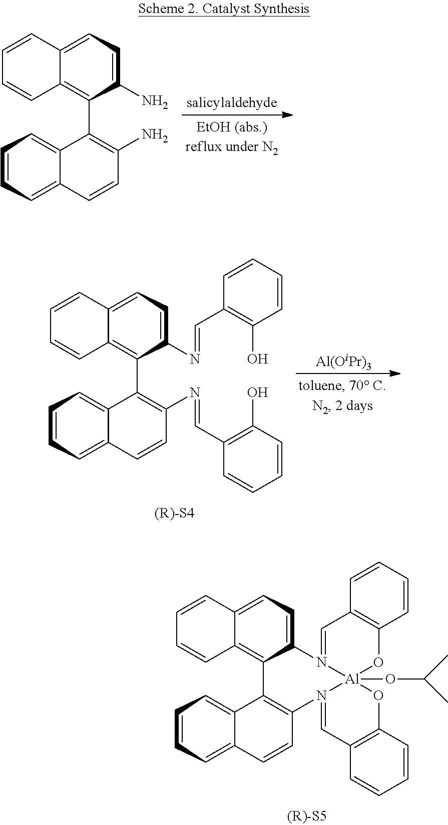

(R)-N,N′-Bis(salicylidene)-1,1′-binaphthyl-2,2′-diamine ((R)-SalBinam) ((R)-S4)

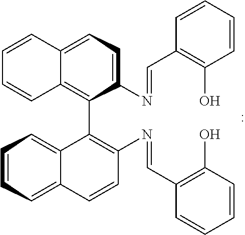

To a round bottom flask, (R)-binaphthyl diamine (BINAM) (102 mg, 0.360 mmol, 1.00 eq.), salicylaldehyde (76.7 μL, 0.720 mmol, 2.00 eq.) and EtOH (abs.) (3.0 mL, 0.12 M) were added. The reaction was heated to reflux overnight under N₂. The mixture turned yellow and formed into a suspension. After reaction, the resulting solid was filtered, wash with cold EtOH, and dried under vacuum overnight, yielding a yellow solid as (R)-SalBinam (quant. yield). ¹H NMR (500 MHz, CDCl₃) δ 12.10 (s, 2H), 8.69 (s, 1H), 8.12 (d, J=8.8 Hz, 1H), 7.98 (d, J=8.2 Hz, 2H), 7.66 (d, J=8.8 Hz, 2H), 7.46 (t, J=7.4 Hz, 2H), 7.29 (t, J=7.6 Hz, 2H), 7.25-7.17 (m, 6H), 6.78 (t, J=7.5 Hz, 2H), 6.74 (d, J=8.3 Hz, 2H); ¹³C NMR (125 MHz, CDCl₃) δ 162.0, 160.9, 143.8, 133.3, 132.95, 132.7, 132.3, 130.2, 129.7, 128.5, 127.2, 126.6, 126.1, 119.4, 118.8, 117.2, 117.0; HRMS (DART-MS): m/z calculated for C₃₄H₂₅N₂O₂ [M+H]⁺493.1916, found 493.1912. Spectral data matched those reported in the literature.

Complex (R)-(SalBinam)AlOⁱPr ((R)-S5)

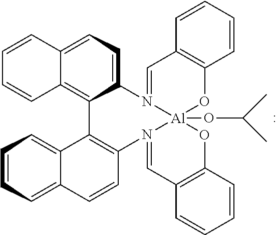

Al(OⁱPr)₃ 99.99+% was purchased from Aldrich and stored under nitrogen as received. In a glovebox, excess Al(OⁱPr)₃ (100 mg) was weighed in a 4 mL vial and sealed with a Teflon-lined cap. It was brought out of the box, heated with heat gun to a liquid and maintained for 1 min. After cooling to room temperature, the heating was repeated for another 4 times, until there was almost no solid left. The heating is to transfer the Al(OⁱPr)₃ from an inactive tetramer (solid) into an active trimer (liquid).

The freshly heated Al(OⁱPr)₃ was brought back to the glovebox. Another 4 mL vial was loaded with freshly heated Al(OⁱPr)₃ (30.6 mg, 0.150 mmol, 1.00 eq.), (R)-SalBinam (73.8 mg, 0.150 mmol, 1.00 eq.), and toluene (2.5 mL, 0.060 M). The vial was capped with a Teflon-lined cap, taken out of the box, taped with parafilm and electrical tape, and heated to 70° C. for 2 days. After reaction, the vial was brought back to glovebox and placed in a drying tube with rubber septum and needle. Solvent was removed in vacuo, yielding a bright yellow solid (quant. yield). (S)-(SalBinam)AlOⁱPr and rac-(SalBinam)AlOⁱPr were synthesized following a similar procedure using the appropriate S or rac isomer of the BINAM starting material. HRMS (DART-MS): m/z calculated for C₃₄H₂₂AlN₂O₂[M-C₃H₇O]⁺517.1497, found 517.1492.

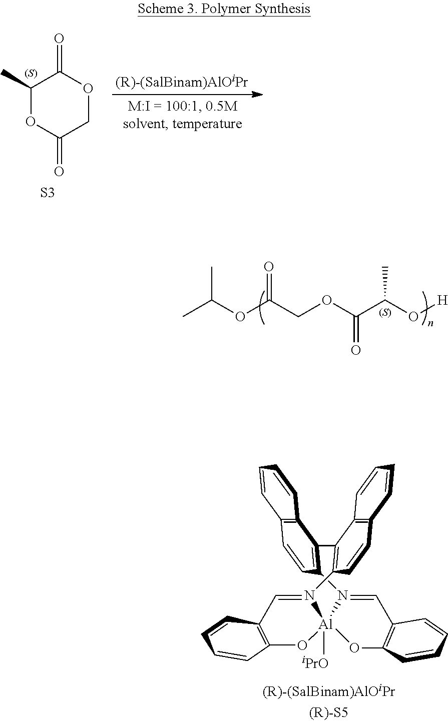

General Procedure for small scale synthesis: In a glovebox, (S)-3-methyl glycolide (S3) (26.0 mg, 0.200 mmol, 100 eq.) was added to an oven-dried 4 mL vial equipped with a Teflon-coated stir bar. Catalyst solution was freshly made at a concentration of 2.88 mg/mL in dry toluene. 0.4 mL of the catalyst solution, containing (R)-(SalBinam)AlOⁱPr (1.15 mg, 2.00 μmol, 1.00 eq.) and toluene (0.4 mL, 0.5 M), was added to the above vial. The vial was capped with a Teflon-lined cap, brought out of the box, taped with parafilm and electrical tape, gently heated with heat gun to ensure monomer dissolution if toluene was used as solvent. It was then heated under stirring at the desired temperature for the certain amount of time. After reaction, the mixture was quenched with one drop of glacial AcOH, and then diluted and transferred with DCM into a round bottom flask. Solvent was removed in vacuo, and the product was re-dissolved with CDCl₃ for NMR. An aliquot was taken, dried and re-dissolved with HPLC-grade THF for GPC. The crude polymer was precipitated with CDCl₃ and EtOH twice to yield a white solid.

General Procedure for large scale synthesis: In a glovebox, (S)-3-methyl glycolide (S3) (291.4 mg, 2.240 mmol, 40.00 eq.), (R)-(SalBinam)AlOⁱPr (32.3 mg, 56.0 μmol, 1.00 eq.) and toluene (4.5 mL, 0.50 M) were added to a flame-dried Schlenk tube equipped with a Teflon-coated stir bar. The Schlenk tube was sealed with a greased glass stopper and a clamp. It was brought out of the box, gently heated with heat gun to ensure monomer dissolution if toluene was used as solvent. It was then heated under stirring at the desired temperature for the certain amount of time. After reaction, the mixture was quenched with 0.5 mL of glacial AcOH, and then diluted and transferred with DCM into a round bottom flask. Solvent was removed in vacuo and re-dissolved with DCM. An aliquot was taken for NMR and GPC. The crude polymer was precipitated with DCM and EtOH twice to yield a white solid. ¹H NMR (600 MHz, CDCl₃) δ 5.25 (q, J=7.1 Hz, 1H), 4.88 (d, J=16.0 Hz, 1H), 4.65 (d, J=16.1 Hz, 1H), 1.59 (d, J=7.1 Hz, 3H); ¹³C NMR (125 MHz, CDCl₃) δ 169.5, 166.6, 69.3, 61.0, 16.9.

The monomer concentration did not have a significant effect on regioselectivity (Table 2, entries 1-4). The polymer dispersity was still narrow at a short reaction time in toluene, indicating that transesterification only started to dominate near full conversion (Table 2, entry 4). Without preheating with heat gun to dissolve all the monomer, the dispersity became a bit higher (Table 2, entries 5 and 6). A wide range of M:I can be achieved under the standard condition (Table 2, entries 2, 6-10). When toluene and (R)-S5 catalyst were used, it was difficult to reach full conversion even at prolonged reaction time and a higher monomer concentration at 35° C. (Table 2, entry 11). However, with (S)-S5 or rac-S5 catalyst under the same condition, it was able to reach a full conversion (Table 2, entries 12 and 13). It could be inferred that, at the beginning stage, the driving force is the ring opening at the less hindered site under steric control. With the increase in polymer chain length, the polymer became sluggish to move around and react any more in toluene due to the poor solubility. However, when (S)-S5 was present, kinetics facilitated the ring-opening to further improve conversion. The favored coordination between (S)-S5 and (S)-LA carbonyl helped to ring-open at the (S)-LA site, and thus it was able to reach a full conversion and a lower regioselectivity. Prolonged reaction time also caused transesterification and slight drop in regioselectivity (Table 2, entries 13 and 14).

Calculation of M_{n theo}:

TABLE 2
Additional Optimization of Reaction Conditions^{a}.

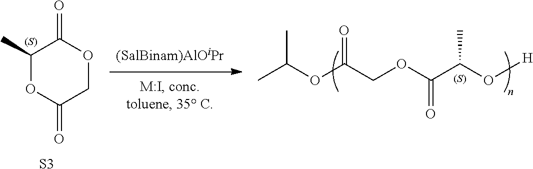

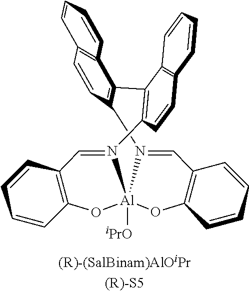

| | | | conc. | time | conv. | M_{n theo} | M_{n GPC} | D | regioselectivity |
|---|---|---|---|---|---|---|---|---|---|
| entry | initiator | M:I | (mol · L⁻¹) | (h) | (%)^{b} | (kDa) | (kDa)^{c} | (M_{w}/Mₙ)^{c} | (%)^{d} |
| 1 | (R)-S5 | 40:1 | 0.25 | 18 | 94 | 4.8 | 7.6 | 1.22 | 97 |
| 2 | (R)-S5 | 40:1 | 0.5 | 17 | 98 | 5.1 | 7.1 | 1.18 | 96 |
| 3 | (R)-S5 | 40:1 | 1.0 | 18 | 99 | 5.2 | 9.0 | 1.12 | 96 |
| 4 | (R)-S5 | 40:1 | 2.0 | 1.5 | 97 | 4.4 | 7.8 | 1.08 | 97 |
| 5^{e} | (R)-S5 | 100:1 | 0.5 | 21 | 72 | 9.4 | 11.8 | 1.17 | 97 |
| 6 | (R)-S5 | 100:1 | 0.5 | 21 | 72 | 9.4 | 13.0 | 1.13 | 97 |
| 7 | (R)-S5 | 80:1 | 0.5 | 23 | 87 | 9.0 | 11.9 | 1.19 | 97 |
| 8 | (R)-S5 | 60:1 | 0.5 | 16 | 94 | 7.4 | 9.7 | 1.17 | 96 |
| 9 | (R)-S5 | 10:1 | 0.5 | 12 | >99 | 1.3 | 2.0 | 1.29 | 90 |
| 10 | (R)-S5 | 5:1 | 0.5 | 16 | >99 | 0.7 | n.d.^{f} | n.d.^{f} | 85 |
| 11 | (R)-S5 | 100:1 | 2.0 | 40 | 77 | 10.0 | 11.6 | 1.30 | 96 |
| 12 | rac-S5 | 100:1 | 0.5 | 40 | >99 | 13.0 | 12.6 | 1.20 | 89 |
| 13 | (S)-S5 | 100:1 | 0.5 | 40 | >99 | 13.0 | 13.8 | 1.27 | 84 |
| 14 | (S)-S5 | 100:1 | 0.5 | 23 | 82 | 10.7 | 13.8 | 1.14 | 85 |
| 15^{g} | (R)-S5 | 100:1 | 0.5 | 21 | 94 | 12.2 | 18.9 | 1.06 | 97 |

^{a}Reaction conditions: all reactions were carried out in toluene at 35° C.
^{b}Determined by ¹H NMR analysis of the crude reaction mixture on reacted and unreacted methine peaks.
^{c}Determined by GPC in THF, calibrated with polystyrene standards.
^{d}Calculated from the integration of regioerror CH₂ peaks and the whole CH₂ region in the ¹H NMR spectrum.
^{e}The solution was not heated with heat gun at the start of the reaction.
^{f}Below GPC detection limit.
^{g}DCE as solvent.

$${M}_{n theo} = conv . \times \frac{M}{I} \times {MW}_{MeG}$$

$${MW}_{MeG} = 130.0 \; 99 \text{g/mol}$$

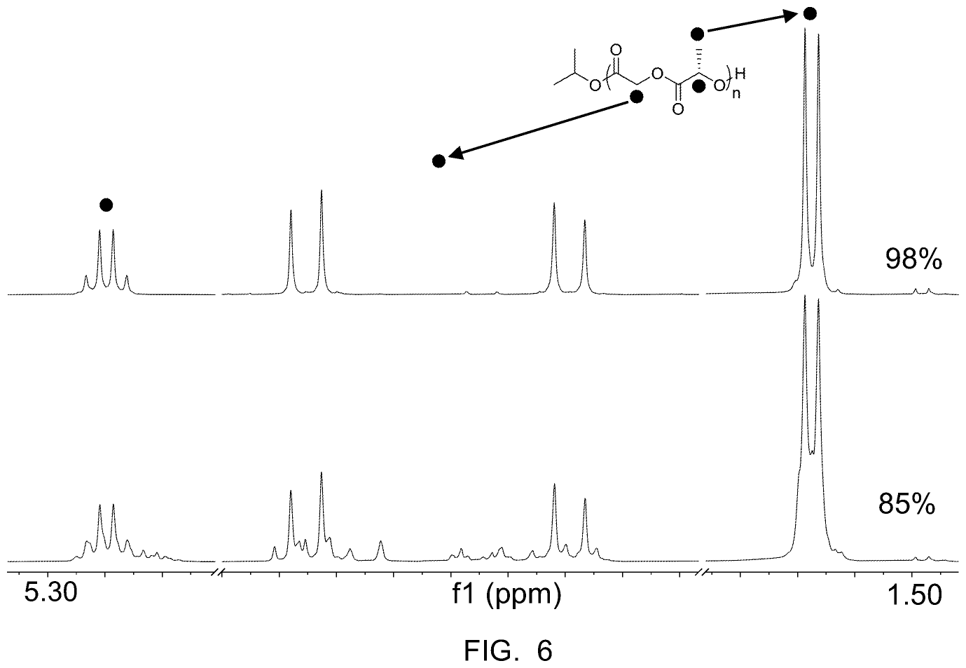

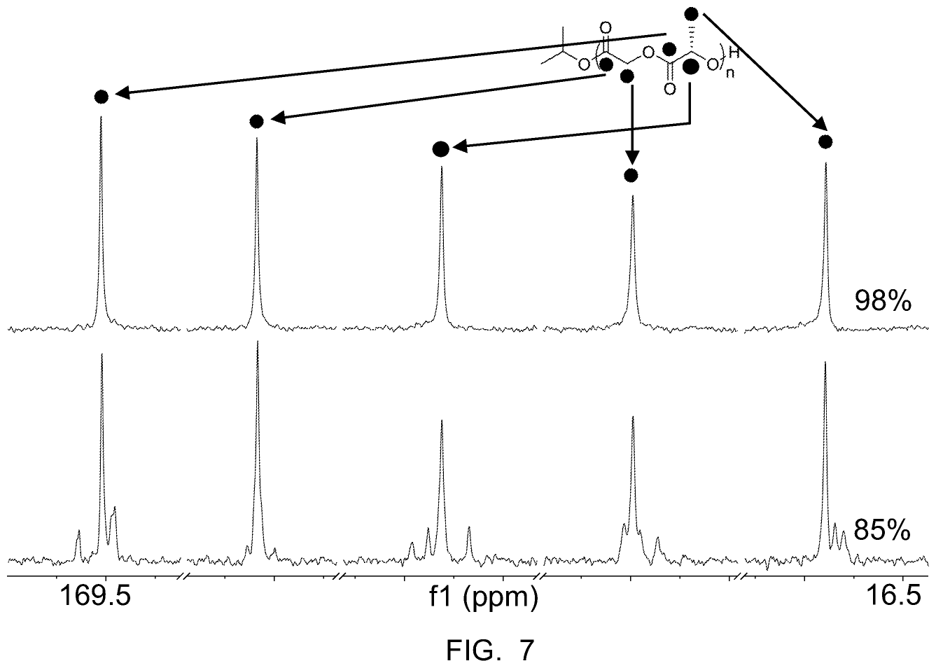

Stacked Polymer ¹H and ¹³C NMR spectra of polymers with varying regioselectivity (Table 1, entry 11=high (98%), and Table 2, entry 14=low (85%), see reaction conditions below) are shown in FIGS. 6 and 7, respectively.

Table 1, entry 11:

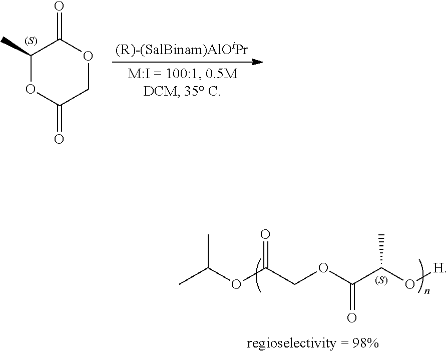

Table 2, entry 14:

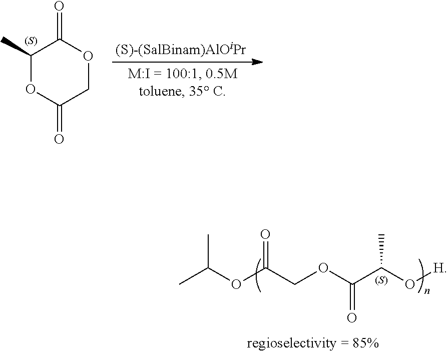

Definition of regioselectivity: Regioselectivity is the ring-opening probability at the preferred site (B) over the sum of ring-opening probabilities at both possible sites (A and B).

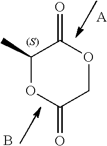

$$regioselectivity = \frac{P ( B )}{P ( A ) + P ( B )} \times 100 \% .$$

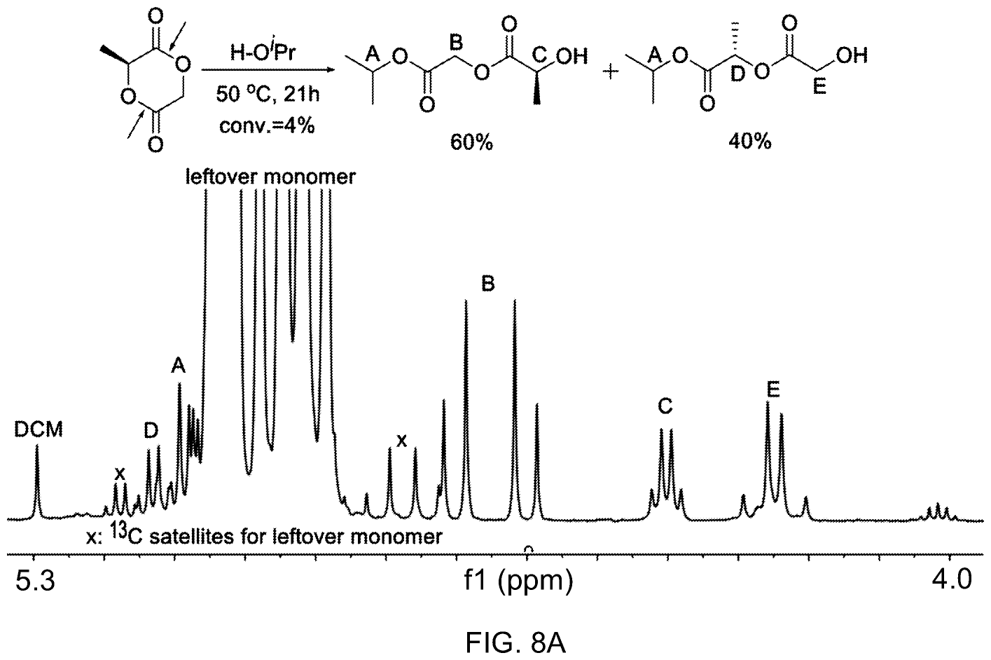

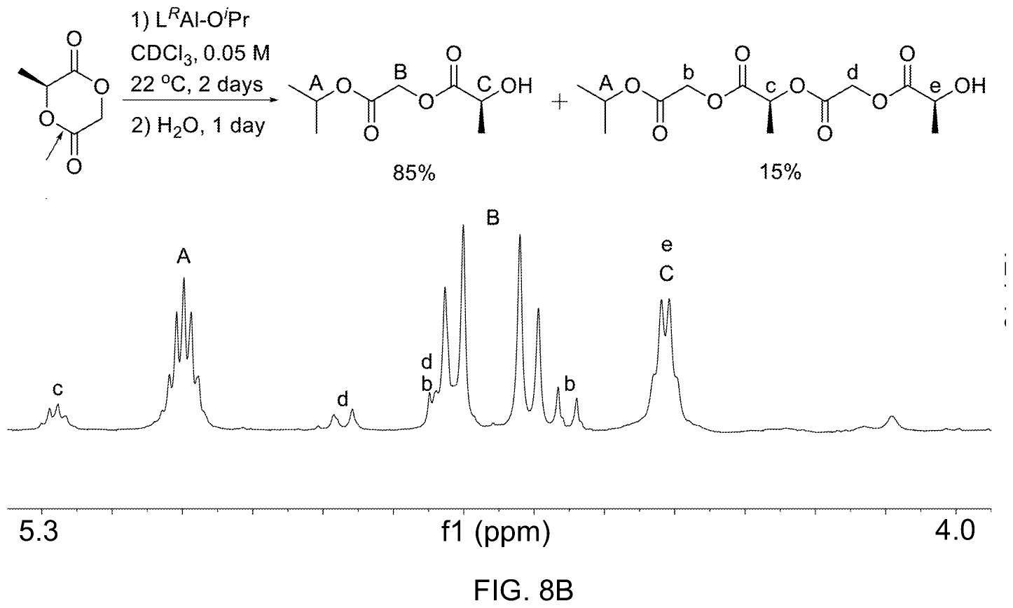

Ring site determination. Ring opening of S3 at M:I=1:1 was performed non-selectively with HOⁱPr at 50° C. for 21 hours, conversion=4% (FIG. 8A). Ring opening of S3 at M:I=1:1 was performed selectively with (R)-(SalBinam)AlOⁱPr in CDCl₃ at 22° C. and quenched with a drop of H₂O, with conv.=100% (FIG. 8B).

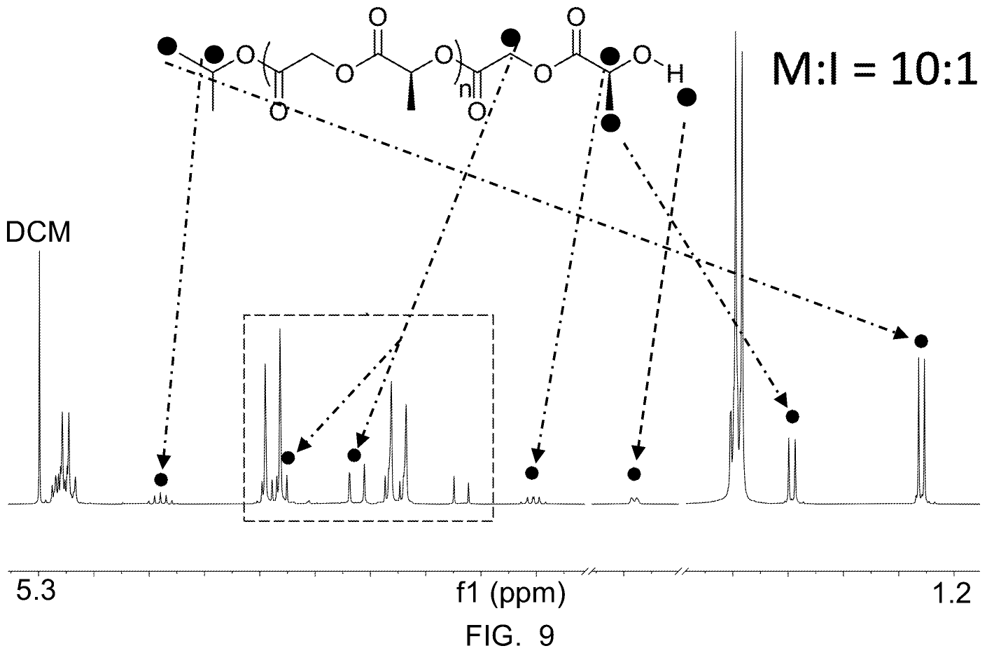

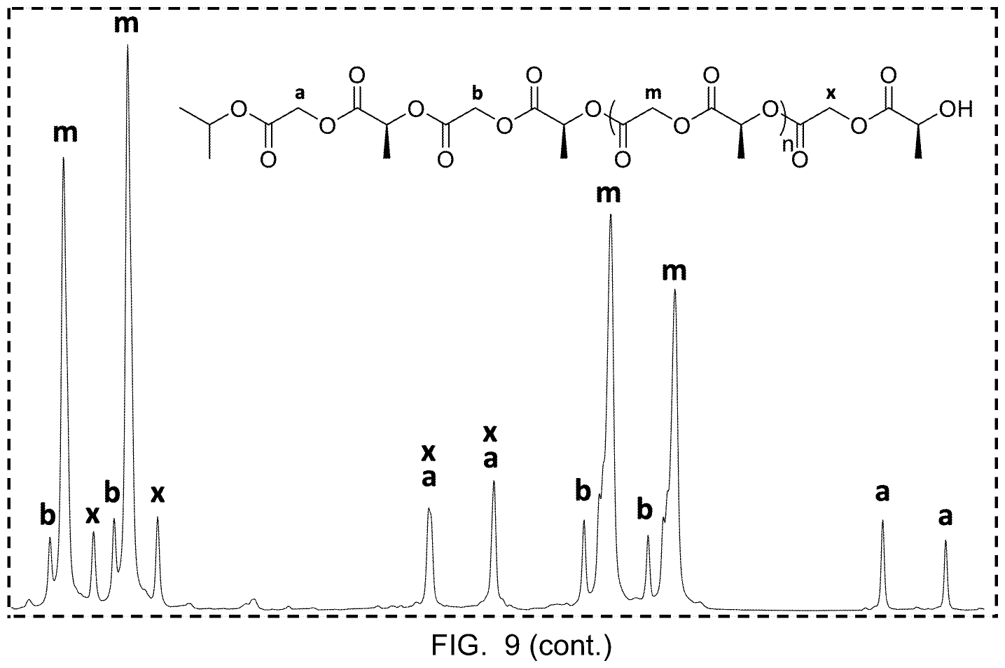

Polymer chain-end groups assignment with M:I=10:1 determined by ¹H NMR for Table 1, entry 16 (see reaction conditions below) is shown in FIG. 9. Table 1, entry 16:

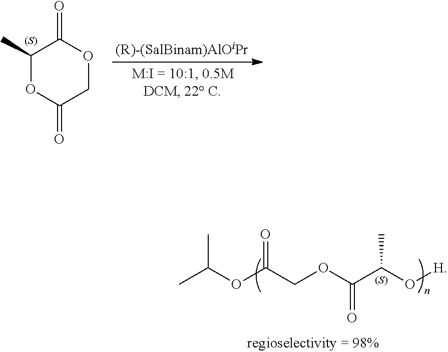

Regioselectivity calculation. The polymer methylene region has two diastereotopic protons, featuring two doublets on NMR. In terms of the error insertion (labelled Red in FIGS. 3B-3C), the error CH₂ diastereotopic protons lie in the regions of δ=4.80-4.85 ppm and δ=4.71-4.76 ppm. Due to the integration feasibility and efficiency, only the 4.80-4.85 ppm region is integrated and used for regioselectivity calculation. The 4.80-4.85 ppm region represents one of the diastereotopic protons, so the integration should be half of the total error CH₂ integration. Therefore, the regioselectivity calculation is given as below:

$$regioselectivity = ( 1 - \frac{2 \times {S}_{err / 2}}{{S}_{all}} ) \times 100 \% .$$

Note that some sharp peaks within 4.50-4.90 ppm are assigned to the chain ends, which are not considered as regioerror peaks, though they may partially overlap with each other. Chain ends typically include but are not limited to δ=4.52, 4.55, 4.71, 4.74 ppm. See FIG. 9 for full chain end assignment.

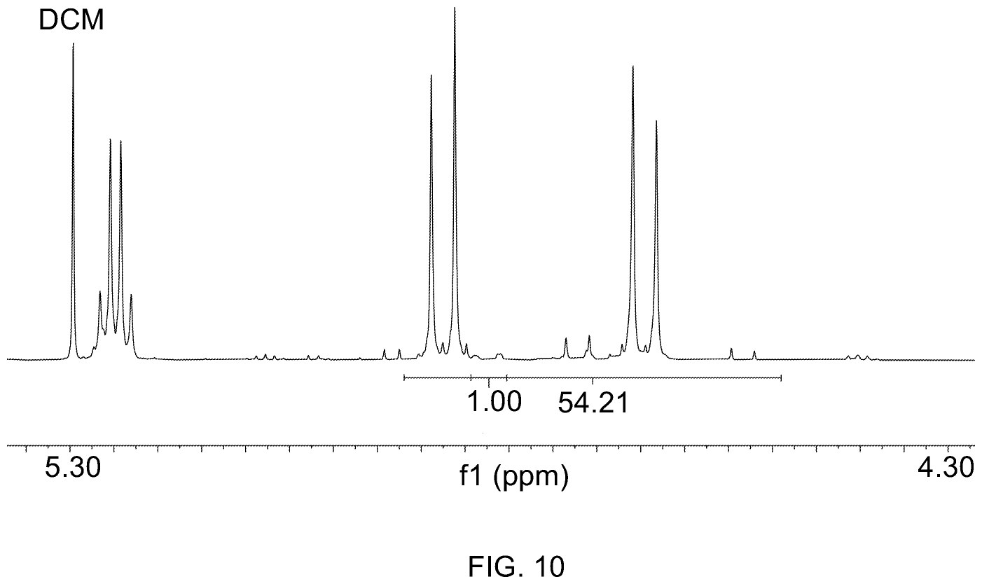

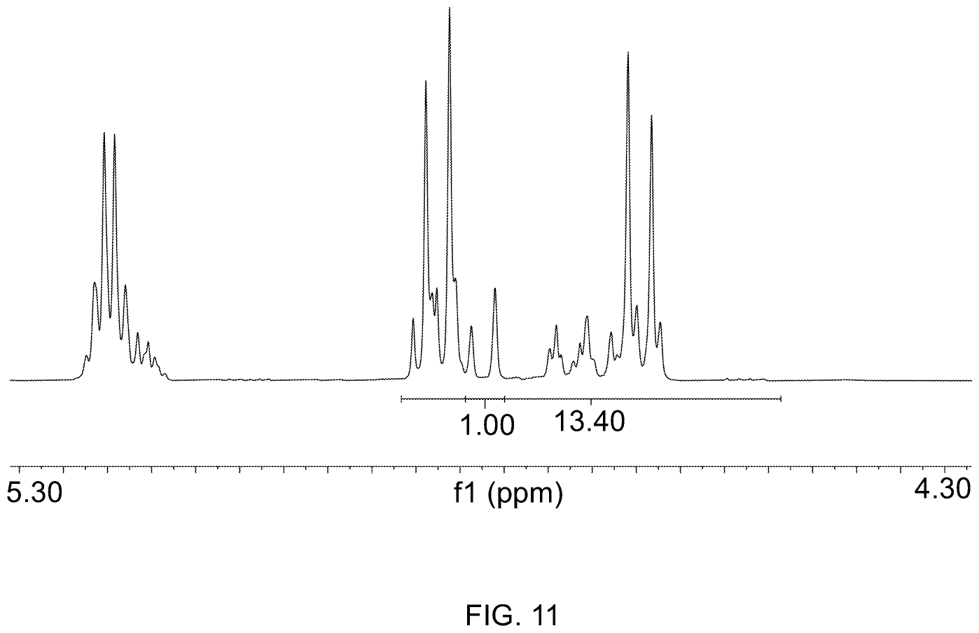

Regioselectivity was calculated (see below) for the samples from Table 1, entry 7 (96%) and Table 2, entry 14 (85%), based on the ¹H NMR spectra shown in FIGS. 10 and 11, respectively.

Table 1, entry 7:

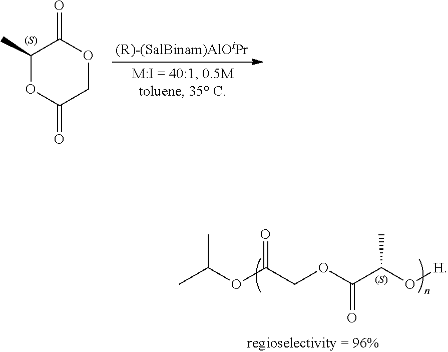

$$regioselectivity = ( 1 - \frac{2 \times 1.}{54.21} ) \times 100 \% = 96 \% .$$

Table 2, entry 14:

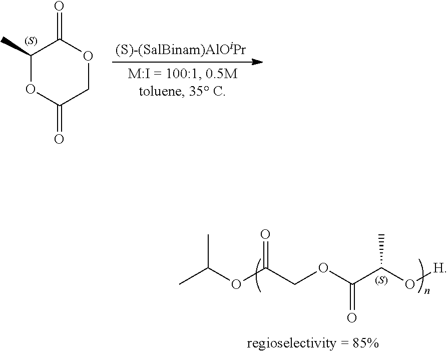

$$regioselectivity = ( 1 - \frac{2 \times 1.00}{13.40} ) \times 100 \% = 85 \%$$

Polymer DSC analysis. DSC analysis of alt-PLGA sample from Table 1, entry 11 was performed. The glass transition temperature (T_{g}) was determined to be 50° C. (onset=48.36° C.; midpoint=49.66° C.; midpoint ASTM_{IEC}=49.61° C.; Delta cp ASTM_{IEC}=0.52 Jg\hat{ }-1K\hat{ }-1.) No melting peak observed on the second heat.

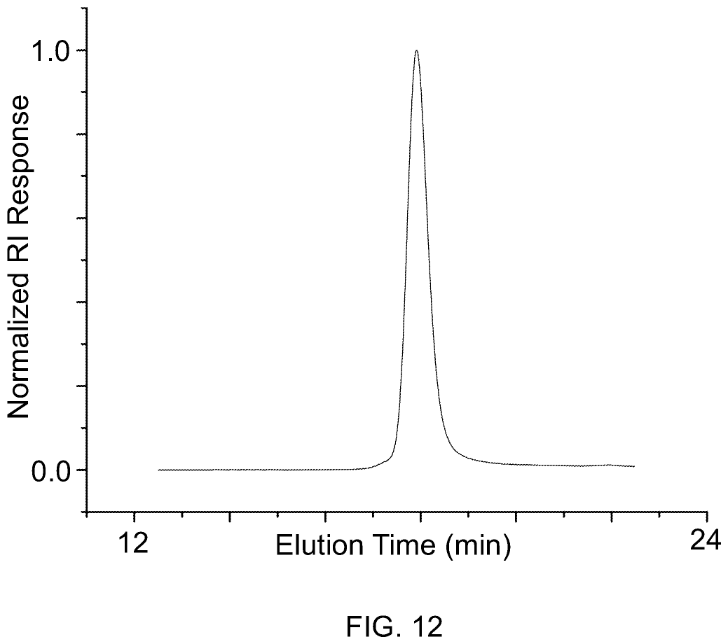

A representative polymer GPC trace of the sample from Table 1, entry 11 is shown in FIG. 12.

Table 1, entry 11:

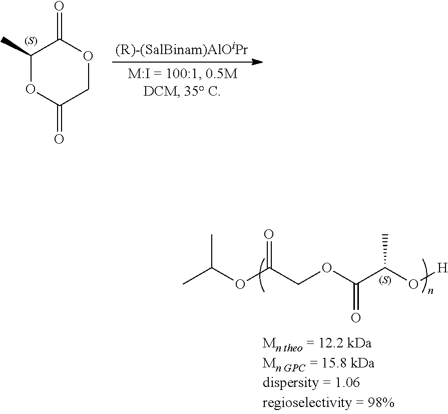

2D Correlation NMR. Band-selective HSQC (600/150 MHz, CDCl₃) of alt-PLGA (regioselectivity=85%) was performed, which showed the glycolic unit region and the lactic unit region. Band-selective HMBC (600/150 MHz, CDCl₃) of alt-PLGA (regioselectivity=85%) was performed, showing methine and methylene regions. Methylene region NMR peak assignments of alt-PLGA (regioselectivity=85%) are shown in Table 3.

TABLE 3
Methylene region NMR peak assignments of alt-PLGA (regioselectivity = 85%).

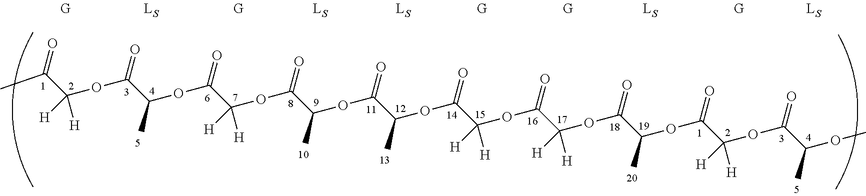

| position | δ_{C} (ppm) | δ_{H} (ppm) | Relevant HMBC correlations |
|---|---|---|---|
| 1 | 166.59 | | |
| 2 | 60.99 | 4.65, 4.88 | 1, 3 |
| 3 | 169.52 | | |
| 4 | 69.31 | 5.25 | 3, 5, 6 |
| 5 | 16.90 | 1.59 | 3, 4 |
| 7 | 60.96 | 4.64, 4.87 | 6, 8 |
| 15 | 61.04 | 4.73, 4.83 | 14, 16 (glycolic carbonyl only) |
| 17 | 60.86 | 4.69, 4.89 | 16, 18 |

### Example 2

The following is an example of polymers of the present disclosure, methods of making and using same.

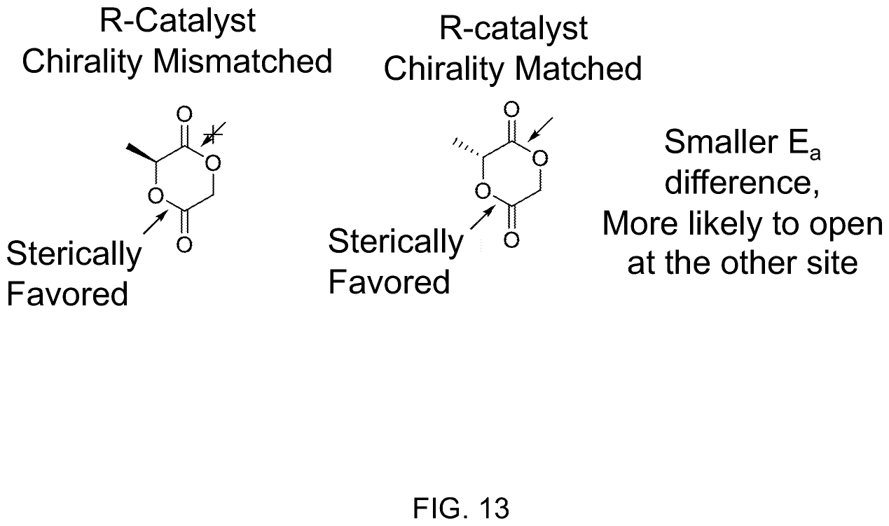

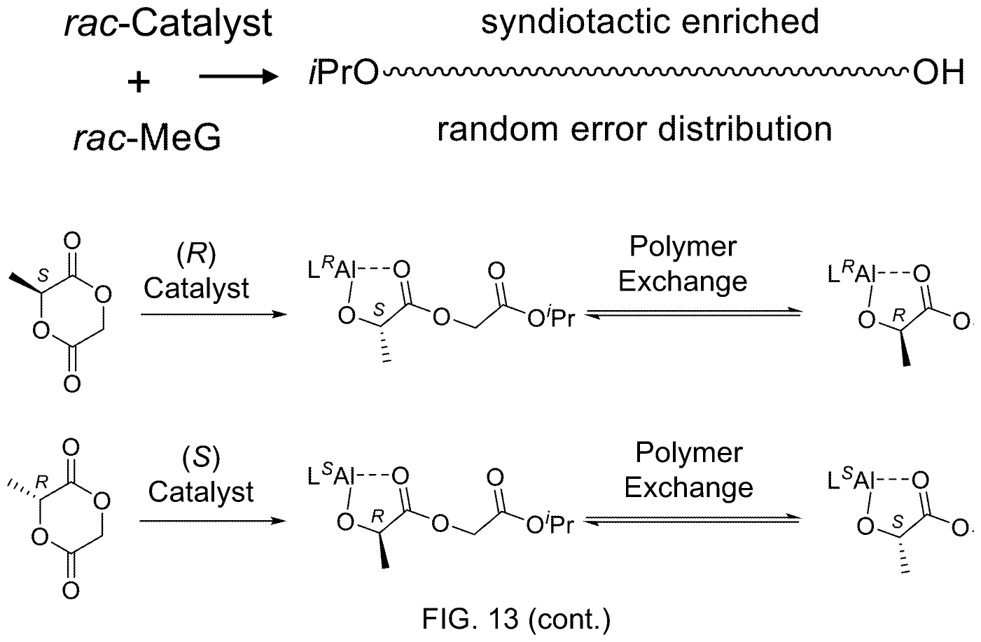

A series of ortho-substituted (R)-(SalBinam)AlOⁱPr initiators and rac-(SalBinam) AlOⁱPr initiators were prepared according to the methods described in Example 1. These initiators were used for ROP of rac-MeG using methods described in Example 1, results shown in Table 4. A proposed polymer exchange mechanism based on these results is shown in FIG. 13.

TABLE 4

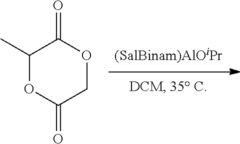

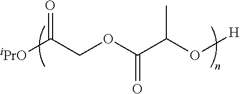

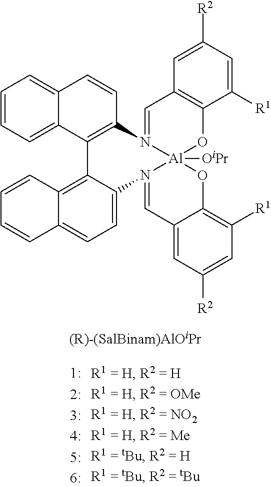

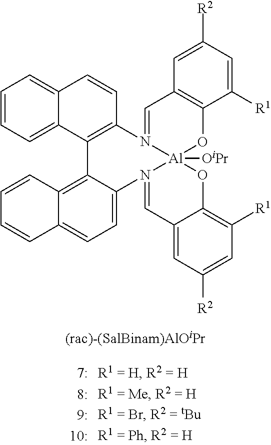

| | | | | | | Regio- | | |
|---|---|---|---|---|---|---|---|---|
| | | | | | | selec- | [mm]: | |
| cata- | Time | conv. | M_{n theo} | M_{n GPC} | | tivity | [mr/rm]: | |
| lyst | (h) | (%) | (kDa) | (kDa) | (M_{w}/Mₙ) | (%) | [rr] | Pr |
| 1 | 23 | 91 | 11.9 | 15.7 | 1.05 | 88 | 25:50:25 | 0.50 |
| 2 | 22 | 89 | 11.6 | 14.2 | 1.06 | 89 | 27:50:23 | 0.48 |
| 3 | 22 | 2 | 0.3 | n.d. | n.d | n.d | n.d. | n.d. |
| 4 | 24 | 75 | 9.8 | 11.9 | 1.04 | 96 | 25:46:29 | 0.54 |
| 5 | 25 | 9 | 1.1 | n.d. | n.d. | 92 | n.d. | n.d. |
| 6 | 25 | 9 | 1.1 | n.d. | n.d. | 93 | n.d. | n.d. |
| 7 | 22 | 96 | 12.4 | 15.4 | 1.06 | 92 | 17:49:34 | 0.58 |
| 8 | 22 | 92 | 11.9 | 15.6 | 1.05 | 97 | 13:44:43 | 0.66 |
| 9 | 20 | 96 | 12.5 | 16.5 | 1.05 | 97 | 6:44:50 | 0.75 |
| 10 | 20 | 91 | 11.8 | 13.5 | 1.06 | 95 | 12:46:42 | 0.65 |

Syndiotacticity (Pᵣ) was calculated according to the following Equations:

[mm]:[mr/rm]:[rr]=a:b:c, where a+b+c=100; [rr]%=Pᵣ×Pᵣ; Pᵣ=\sqrt{[rr]%}=\sqrt{c%}

Although the present disclosure has been described with respect to one or more particular example(s), it will be understood that other examples of the present disclosure may be made without departing from the scope of the present disclosure.

1. A method of making a polymer comprising:
forming a reaction mixture comprising:
one or more monomer(s) having the following structure: 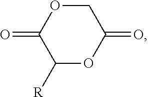
wherein R is independently at each occurrence chosen from alkyl groups, aryl groups, and any combination thereof;
one or more initiator(s) independently at each occurrence comprising the following structure: LM—X, wherein M is a metal, L is a polydentate ligand, and X is a ligand chosen from a hydroxide group, alkoxide groups, aryloxide groups, alkyl groups, ester groups, amido groups, and azide groups; and
optionally, one or more solvent(s);
wherein a polymer is formed.

2. The method of claim 1, wherein the reaction mixture comprises:
(S)- 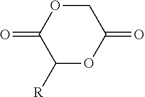
monomer(s) and (R)—LM—X initiator(s);
(R)- 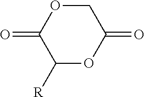
monomer(s) and (S)—LM—X initiator(s); or rac- 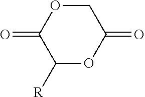
monomer(s) and rac-LM—X initiator(s).

3. The method of claim 1, wherein the ligand (X) of at least one of the initiator(s) is an alkoxide group.

4. The method of claim 1, wherein the metal (M) of at least one of the initiator(s) is chosen from aluminum, zinc, yttrium, and any combination thereof.

5. The method of claim 1, wherein the polydentate ligand (L) of at least one of the initiator(s) is chosen from N,N′-bis(salicylidene)-1,1′-binaphthyl-2,2′-diamine (SalBinam) ligands, N,N′-bis(salicylidene)-1,2-diaminocyclohexane (Salcy) ligands, analogs thereof, derivatives thereof, and any combination thereof.

6. The method of claim 5, wherein at least one of the initiator(s) is chosen from (R)-(SalBinam)M—X initiator(s), (S)-(SalBinam)M—X initiator(s), rac-(SalBinam)M—X initiator(s), (R, R)-(Salcy)M—X initiator(s), (S, S)-(Salcy)M—X initiator(s), analogs thereof, derivatives thereof, and any combination thereof, wherein X is independently at each occurance chosen from alkoxy groups, aryloxy groups, ester groups, and any combination thereof.

7. The method of claim 6, wherein at least one of the initiator(s) is chosen from (R)-(SalBinam)AlOⁱPr initiator(s), (S)-(SalBinam)AlOⁱPr initiator(s), rac-(SalBinam)AlOⁱPr initiator(s), (R, R)-(Salcy)AlOⁱPr initiator(s), (S, S)-(Salcy)AlOⁱPr initiator(s), analog(s) thereof, derivative(s) thereof, and any combination thereof.

8. The method of claim 7, wherein at least one of the initiator(s) has the following structure: 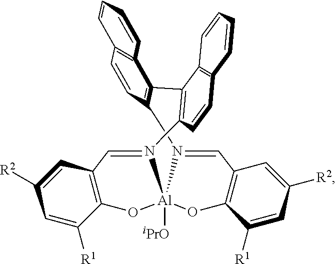
wherein R¹ and R² are each independently at each occurrence chosen from a hydrogen group, halide groups, alkyl groups, alkoxy groups, and aryl groups.

9. The method of claim 1, wherein at least one of the monomer(s) is

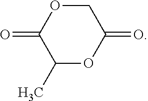

10. The method of claim 7, wherein the reaction mixture comprises:
(S)- 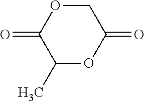
and (R)-(SalBinam)AlOⁱPr initiator(s);
(R)- 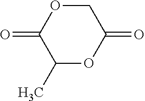
and (S)-(SalBinam)AlOⁱPr initiator(s); or
rac- 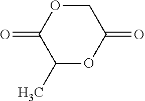
and rac-(SalBinam)AlOⁱPr initiator(s).

11. The method of claim 1, wherein at least one of the monomer(s) is present in the reaction mixture at from about 0.05 M to about 3 M.

12. The method of claim 1 wherein the molar ratio of the monomer(s) to the initiator(s) in the reaction mixture is from about 5:1 to about 1000:1.

13. The method of claim 1, wherein at least one of the solvent(s) is chosen from aromatic solvents, chlorinated solvents, and ether solvents, and any combination thereof.

14. The method of claim 1, wherein the reaction mixture is heated to, cooled to, or held, or any combination thereof, at a temperature of from about −40° C. to about 100° C.

15. The method of claim 14, wherein the reaction mixture is heated to, cooled to, or held, or any combination thereof, at the temperature for from about 1 hours to about 50 hours.

16. The method of claim 1, further comprising, after forming the polymer, adding one or more quenching agent(s) to the reaction mixture.

17. The method of claim 16, wherein at least one of the quenching agent(s) is chosen from water, mineral acid(s), carboxylic acids, carboxylic anhydrides, halocarboxylic acids, halocarboxylic anhydrides, alcohols, and any combination thereof.

18. The method of claim 1, further comprising, after forming the polymer, isolating and/or purifying the polymer.

19. The method of claim 1, wherein the polymer comprises greater than about 90% glycolic-unit-lactic unit (G—L) linkages.

20. A polymer comprising the following structure: 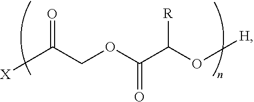
wherein n is from about 5 to about 1000, including all integer values and ranges therebetween,
wherein R is independently at each occurrence chosen from alkyl groups and aryl groups, and
wherein X is chosen from a hydroxide group, alkoxide groups, aryloxide groups, alkyl groups, ester groups, amido groups, azide groups, and any combination thereof.

21. The polymer of claim 20, wherein the polymer comprises greater than about 90% glycolic unit-lactic unit (G—L) linkages.

22. The polymer of claim 20, wherein the polymer has the following structure:

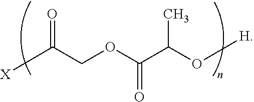

23. The polymer of claim 20, wherein the polymer is isotactic, isotactic-enriched, syndiotactic-enriched, or atactic.

24. The polymer of claim 20, wherein the polymer has a molecular mass (M_{w} and/or Mₙ) of from about 1 kiloDaltons (kDa) to about 130 kDa.

25. The polymer of claim 20, wherein polymer has a dispersity (Ð) of from about 1.01 to about 3.0.

26. The polymer of claim 20, wherein the polymer has a glass transition temperature (T_{g}) of from about 30° C. to about 80° C.

27. The polymer of claim 20, wherein the polymer in the form of a solution, an emulsion, a slurry, a dispersion, a particle, a flake, a pellet, a powder, a granule, a tube, a sphere, a fiber, a foam, a film, a textile, a mesh, a sheet, a bar, or a monolith.

28. An article of manufacture comprising one or more polymer(s) of claim 20.

29. The article of claim 28, wherein the article is a spun article, a molded article, an extruded article, a cast article, a blown article, a woven article, a drawn article, an extruded article, a laminated article, a spin coated article, an adhesive article, or a 3D printed article.
